(19) United States
(12) Patent Application Publication
(10) Pub. No.: US 2020/0009982 A1
(43) Pub. Date: Jan. 9, 2020

(54) METHOD FOR CHARGING BATTERY OF AUTONOMOUS VEHICLE AND APPARATUS THEREFOR

(71) Applicant: LG Electronics Inc., Seoul (KR)

(72) Inventor: Cheolseung KIM, Seoul (KR)

(21) Appl. No.: 16/576,265

(22) Filed: Sep. 19, 2019

(30) Foreign Application Priority Data
Aug. 20, 2019 (KR) 10-2019-0102016

(51) Int. Cl. B60L 53/66; H02J 7/02; H02J 50/90; H02J 50/80; B60L 53/126; B60L 53/38; B60L 53/50; B60L 53/62; G05D 1/02; G08G 1/01

(52) U.S. Cl. CPC B60L 53/66; G05D 2201/0213; H02J 50/90; H02J 50/80; B60L 53/126; B60L 53/38; B60L 53/50; B60L 53/62; G05D 1/0217; G08G 1/0116; G08G 1/0145; G05D 1/0223; B60L 2240/622; B60L 2240/68; B60L 2240/72; H02J 7/025

(57) ABSTRACT

Provided is a method for charging a battery performed by a charging vehicle in an autonomous driving system. The charging vehicle receives a request message requesting charging of a battery of a driving vehicle from a control center, and the request message includes first location information related to a location of the driving vehicle and battery information related to a remaining battery capacity of the driving vehicle. Thereafter, the charging vehicle receives a control message including charging information for charging the battery of the driving vehicle from the control center, and the charging information includes road location information related to a road location for the battery charging, lane information related to an occupancy lane occupied for charging, and time information. Thereafter, the charging vehicle moves to a location adjacent to the driving vehicle, and the battery of the driving vehicle is charged in the occupancy lane.

### CROSS-REFERENCE TO RELATED APPLICATIONS

This application claims the benefit of priority to Korea Patent Application No. 10-2019-0102016, filed on Aug. 20, 2019, which is incorporated herein by reference for all purposes as if fully set forth herein.

### BACKGROUND OF THE INVENTION

### Field of the Invention

The present invention relates to a method for charging a battery of an autonomous vehicle and an apparatus therefor, and particularly, a method of charging a battery of an autonomous vehicle using battery charging provided from another autonomous vehicle providing the battery charging and an apparatus therefor.

### Related Art

Vehicles can be classified into an internal combustion engine vehicle, an external combustion engine vehicle, a gas turbine vehicle, an electric vehicle, etc. according to types of motors used therefor.

An autonomous vehicle refers to a self-driving vehicle that can travel without an operation of a driver or a passenger, and an autonomous driving system refers to systems that monitor and control the autonomous vehicle such that the autonomous vehicle can perform self-driving.

Recently, among autonomous vehicles, the electric vehicle has been developed and commercialized, and in order to charge the autonomous electric vehicle, the electric vehicle moves to a charging station, is parked on a wireless charging device, and thereafter, is charged while waiting for a long time.

### SUMMARY OF THE INVENTION

The present invention aims to achieve the above-described needs and/or to solve the above-described problems.

The present invention also provides a method for charging a battery of an autonomous vehicle driving on a road in an autonomous driving system and an apparatus therefor.

The present invention also provides a method for occupying a specific road according to a vehicle traffic of a road in order to charge a battery of an autonomous electric vehicle driving in the autonomous driving system and an apparatus therefor.

While a battery of a driving vehicle is charged, if another vehicle is found in a driving lane, the present invention provides a method for moving the found vehicle for charging the battery and an apparatus therefor.

The present invention also provides a method for moving a location of a charging vehicle according to a location of a wireless charging device for charging the battery of the driving vehicle and an apparatus therefor.

The present invention also provides a method for moving a charging vehicle and a wireless charging device of the charging vehicle according to a road situation (traffic, whether or not adjacent vehicle exists, slope and/or curvature of road) to charge the battery of the driving vehicle and an apparatus therefor.

Technical objects to be solved by the present invention are not limited to the technical objects mentioned above, and other technical objects that are not mentioned will be apparent to a person skilled in the art from the following detailed description of the invention.

The present invention provides a method for charging a battery performed by a charging vehicle in an autonomous driving system.

According to the present invention, the method includes receiving a request message requesting charging of a battery of a driving vehicle from a control center, the request message including first location information related to a location of the driving vehicle and battery information related to a remaining battery capacity of the driving vehicle, receiving a control message including charging information for charging the battery of the driving vehicle from the control center, the charging information including road location information related to a road location for the battery charging, lane information related to an occupancy lane occupied for charging, and time information related to an occupancy time of the occupancy lane, moving the charging vehicle to a location adjacent to the driving vehicle based on the first location information, and charging the battery of the driving vehicle in the occupancy lane based on the charging information.

In the present invention, the charging information may be generated based on a current location of the driving vehicle and/or traffic congestion on a path to a destination.

In the present invention, the method may further include acquiring second location information indicating locations of wireless charging devices for the battery charging from the driving vehicle, and acquiring charging location information related to a location of a first wireless charging device for the battery charging among the wireless charging devices from a user.

In the present invention, the method may further include moving the charging vehicle to a location closest to the first wireless charging device based on the charging location information.

In the present invention, the method may further include, when strength of a magnetic field for the battery charging is smaller than the minimum threshold value, adjusting a voltage value and/or a current value so as to increase the strength of the magnetic field.

In the present invention, the method may further include, when other vehicles drive in the occupancy lane, transmitting a lane change request message requesting that other vehicles change a lane to other vehicles, and a speed of the charging vehicle may be adjusted so that the charging vehicle is located within a predetermined distance from the driving vehicle.

In the present invention, the method may further include, when heights of the driving vehicle and the charging vehicle are different from each other, moving the driving vehicle and the charging vehicle so that a center portion of a first wireless charging device of the driving vehicle and a center portion of a second wireless charging device of the charging vehicle are located at the same location as each other in a horizontal axis.

In the present invention, the method may further include moving the charging vehicle to a location at which the strength of the magnetic field for the battery charging is the strongest.

In the present invention, a second wireless charging device of the charging vehicle may move along a location of a first wireless charging device of the driving vehicle.

In another aspect, a method for charging a battery performed by a driving vehicle in an autonomous driving system is provided. The method includes transmitting a request message requesting charging of a battery during driving to a control center, the request message including location information related to a location of the driving vehicle and battery information related to a remaining battery capacity of the driving vehicle, receiving a charging message including charging information related to battery charging via a charging vehicle through a road side unit (RSU) from the control center, the charging information including location information related to a road location for the battery charging, lane information related to an occupancy lane occupied for charging, and time information related to an occupancy time of the occupancy lane, and performing an operation for charging the battery when the charging vehicle approaches.

In the present invention, the method may further include receiving an input of charging location information related to a location of a wireless charging device for the charging the battery, from a user of the driving vehicle.

In still another aspect, a charging vehicle for battery charging in an autonomous driving system is provided. The charging vehicle includes a wireless charging device for wireless charging, a transmitter and a receiver configured to communicate with a sever, and a processor configured to be functionally connected to the transmitter and the receiver. The processor receives a request message requesting charging of a battery of a driving vehicle from a control center, and the request message includes location information related to a location of the driving vehicle and battery information related to a remaining battery capacity of the driving vehicle. The processor receives a control message including charging information for charging the battery of the driving vehicle from the control center, and the charging information includes location information related to a road location for the battery charging, lane information related to an occupancy lane occupied for charging, and time information related to an occupancy time of the occupancy lane. The charging vehicle moves to a location adjacent to the driving vehicle based on the location information, and the battery of the driving vehicle is charged in the occupancy lane based on the charging information.

In the present invention, the charging information may be generated based on a current location of the driving vehicle and/or traffic congestion on a path to a destination.

In the present invention, the processor may acquire charging location information related to a location of a first wireless charging device for the battery charging from the driving vehicle.

In the present invention, the processor may move the charging vehicle to a location closest to the first wireless charging device based on the charging location information.

In the present invention, when strength of a magnetic field for the battery charging is smaller than the minimum threshold value, the processor may adjust a voltage value and/or a current value so as to increase the strength of the magnetic field.

In the present invention, when other vehicles drive in the occupancy lane, the processor may transmit a lane change request message requesting that other vehicles change a lane to other vehicles and adjust a speed of the charging vehicle so that the charging vehicle is located within a predetermined distance from the driving vehicle.

In the present invention, when heights of the driving vehicle and the charging vehicle are different from each other, the processor may move the driving vehicle and the charging vehicle so that a center portion of a first wireless charging device of the driving vehicle and a center portion of a second wireless charging device of the charging vehicle are located at the same location as each other in a horizontal axis.

In the present invention, the processor may move the charging vehicle to a location at which the strength of the magnetic field for the battery charging is the strongest.

In the present invention, a second wireless charging device of the charging vehicle may move along a location of a first wireless charging device of the driving vehicle.

### BRIEF DESCRIPTION OF THE DRAWINGS

The accompanying drawings, which are included to provide a further understanding of the invention and are incorporated in and constitute a part of this application, illustrate embodiments of the invention and together with the description serve to explain the principle of the invention.

FIG. 1 is a block diagram of a wireless communication system to which methods proposed in the disclosure are applicable.

FIG. 2 shows an example of a signal transmission/reception method in a wireless communication system.

FIG. 3 shows an example of basic operations of an autonomous vehicle and a 5G network in a 5G communication system.

FIG. 4 shows an example of a basic operation between vehicles using 5G communication.

FIG. 5 illustrates a vehicle according to an embodiment of the present invention.

FIG. 6 is a control block diagram of the vehicle according to an embodiment of the present invention.

FIG. 7 is a control block diagram of an autonomous device according to an embodiment of the present invention.

FIG. 8 is a diagram showing a signal flow in an autonomous vehicle according to an embodiment of the present invention.

FIG. 9 is a diagram for describing a use scenario of a user according to an embodiment of the present invention.

FIG. 10 illustrates V2X communication to which the present invention is applicable.

FIGS. 11A and 11B illustrate a resource allocation method in a sidelink in which V2X is used.

FIG. 12 shows an example of a method for charging a battery of a vehicle during driving of the vehicle in an autonomous driving system according to an embodiment of the present invention.

FIG. 13 shows an example of a method for charging the battery of the driving vehicle in the autonomous driving system according to an embodiment of the present invention.

FIG. 14 shows an example of a method for charging the battery of the driving vehicle by a charging vehicle in the autonomous driving system according to an embodiment of the present invention.

FIG. 15 shows an example of a method for determining a charging location using an audio video navigation (AVN) system according to an embodiment of the present invention.

FIG. 16 shows an example of a method for charging the battery during driving in the autonomous driving system according to an embodiment of the present invention.

FIGS. 17A to 19 show an example of a change in a location of the charging vehicle according to a location of the driving vehicle in the autonomous driving system according to an embodiment of the present invention.

FIG. 20 shows an example of a method for determining locations of the driving vehicle and the charging vehicle during driving according to a status of a road according to an embodiment of the present invention.

### DESCRIPTION OF EXEMPLARY EMBODIMENTS

Hereinafter, embodiments of the disclosure will be described in detail with reference to the attached drawings. The same or similar components are given the same reference numbers and redundant description thereof is omitted. The suffixes “module” and “unit” of elements herein are used for convenience of description and thus can be used interchangeably and do not have any distinguishable meanings or functions. Further, in the following description, if a detailed description of known techniques associated with the present invention would unnecessarily obscure the gist of the present invention, detailed description thereof will be omitted. In addition, the attached drawings are provided for easy understanding of embodiments of the disclosure and do not limit technical spirits of the disclosure, and the embodiments should be construed as including all modifications, equivalents, and alternatives falling within the spirit and scope of the embodiments.

While terms, such as “first”, “second”, etc., may be used to describe various components, such components must not be limited by the above terms. The above terms are used only to distinguish one component from another.

When an element is “coupled” or “connected” to another element, it should be understood that a third element may be present between the two elements although the element may be directly coupled or connected to the other element. When an element is “directly coupled” or “directly connected” to another element, it should be understood that no element is present between the two elements.

The singular forms are intended to include the plural forms as well, unless the context clearly indicates otherwise.

In addition, in the specification, it will be further understood that the terms “comprise” and “include” specify the presence of stated features, integers, steps, operations, elements, components, and/or combinations thereof, but do not preclude the presence or addition of one or more other features, integers, steps, operations, elements, components, and/or combinations.

A. Example of block diagram of UE and 5G network

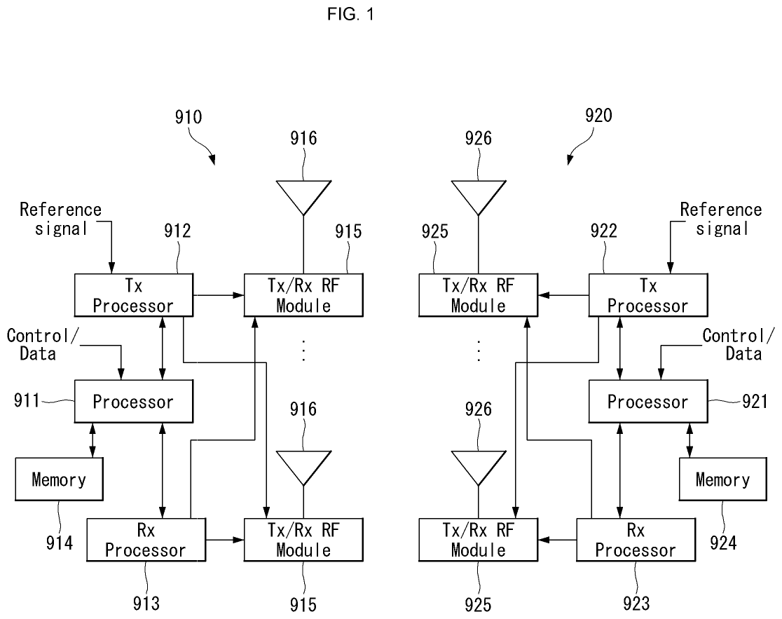

FIG. 1 is a block diagram of a wireless communication system to which methods proposed in the disclosure are applicable.

Referring to FIG. 1, a device (autonomous device) including an autonomous module is defined as a first communication device (910 of FIG. 1), and a processor 911 can perform detailed autonomous operations.

A 5G network including another vehicle communicating with the autonomous device is defined as a second communication device (920 of FIG. 1), and a processor 921 can perform detailed autonomous operations.

The 5G network may be represented as the first communication device and the autonomous device may be represented as the second communication device.

For example, the first communication device or the second communication device may be a base station, a network node, a transmission terminal, a reception terminal, a wireless device, a wireless communication device, an autonomous device, or the like.

For example, a terminal or user equipment (UE) may include a vehicle, a cellular phone, a smart phone, a laptop computer, a digital broadcast terminal, personal digital assistants (PDAs), a portable multimedia player (PMP), a navigation device, a slate PC, a tablet PC, an ultrabook, a wearable device (e.g., a smartwatch, a smart glass and a head mounted display (HMD)), etc. For example, the HMD may be a display device worn on the head of a user. For example, the HMD may be used to realize VR, AR or MR. Referring to FIG. 1, the first communication device 910 and the second communication device 920 include processors 911 and 921, memories 914 and 924, one or more Tx/Rx radio frequency (RF) modules 915 and 925, Tx processors 912 and 922, Rx processors 913 and 923, and antennas 916 and 926. The Tx/Rx module is also referred to as a transceiver. Each Tx/Rx module 915 transmits a signal through each antenna 926. The processor implements the aforementioned functions, processes and/or methods. The processor 921 may be related to the memory 924 that stores program code and data. The memory may be referred to as a computer-readable medium. More specifically, the Tx processor 912 implements various signal processing functions with respect to L1 (i.e., physical layer) in DL (communication from the first communication device to the second communication device). The Rx processor implements various signal processing functions of L1 (i.e., physical layer).

UL (communication from the second communication device to the first communication device) is processed in the first communication device 910 in a way similar to that described in association with a receiver function in the second communication device 920. Each Tx/Rx module 925 receives a signal through each antenna 926. Each Tx/Rx module provides RF carriers and information to the Rx processor 923. The processor 921 may be related to the memory 924 that stores program code and data. The memory may be referred to as a computer-readable medium.

B. Signal Transmission/Reception Method in Wireless Communication System

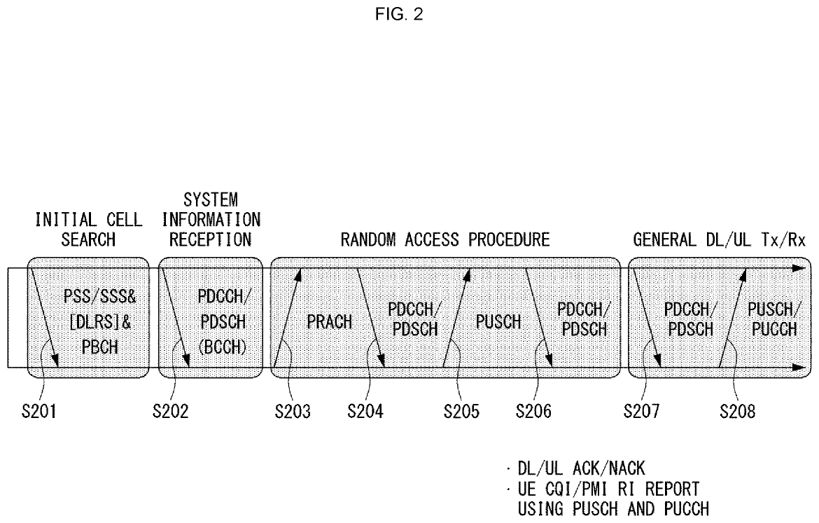

FIG. 2 is a diagram showing an example of a signal transmission/reception method in a wireless communication system.

Referring to FIG. 2, when a UE is powered on or enters a new cell, the UE performs an initial cell search operation such as synchronization with a BS (S201). For this operation, the UE can receive a primary synchronization channel (P-SCH) and a secondary synchronization channel (S-SCH) from the BS to synchronize with the BS and acquire information such as a cell ID. In LTE and NR systems, the P-SCH and S-SCH are respectively called a primary synchronization signal (PSS) and a secondary synchronization signal (SSS). After initial cell search, the UE can acquire broadcast information in the cell by receiving a physical broadcast channel (PBCH) from the BS. Further, the UE can receive a downlink reference signal (DL RS) in the initial cell search step to check a downlink channel state. After initial cell search, the UE can acquire more detailed system information by receiving a physical downlink shared channel (PDSCH) according to a physical downlink control channel (PDCCH) and information included in the PDCCH (S202).

Meanwhile, when the UE initially accesses the BS or has no radio resource for signal transmission, the UE can perform a random access procedure (RACH) for the BS (steps S203 to S206). To this end, the UE can transmit a specific sequence as a preamble through a physical random access channel (PRACH) (S203 and S205) and receive a random access response (RAR) message for the preamble through a PDCCH and a corresponding PDSCH (S204 and S206). In the case of a contention-based RACH, a contention resolution procedure may be additionally performed.

After the UE performs the above-described process, the UE can perform PDCCH/PDSCH reception (S207) and physical uplink shared channel (PUSCH)/physical uplink control channel (PUCCH) transmission (S208) as normal uplink/downlink signal transmission processes. Particularly, the UE receives downlink control information (DCI) through the PDCCH. The UE monitors a set of PDCCH candidates in monitoring occasions set for one or more control element sets (CORESET) on a serving cell according to corresponding search space configurations. A set of PDCCH candidates to be monitored by the UE is defined in terms of search space sets, and a search space set may be a common search space set or a UE-specific search space set. CORESET includes a set of (physical) resource blocks having a duration of one to three OFDM symbols. A network can configure the UE such that the UE has a plurality of CORESETs. The UE monitors PDCCH candidates in one or more search space sets. Here, monitoring means attempting decoding of PDCCH candidate(s) in a search space. When the UE has successfully decoded one of PDCCH candidates in a search space, the UE determines that a PDCCH has been detected from the PDCCH candidate and performs PDSCH reception or PUSCH transmission on the basis of DCI in the detected PDCCH. The PDCCH can be used to schedule DL transmissions over a PDSCH and UL transmissions over a PUSCH. Here, the DCI in the PDCCH includes downlink assignment (i.e., downlink grant (DL grant)) related to a physical downlink shared channel and including at least a modulation and coding format and resource allocation information, or an uplink grant (UL grant) related to a physical uplink shared channel and including a modulation and coding format and resource allocation information.

An initial access (IA) procedure in a 5G communication system will be additionally described with reference to FIG. 2.

The UE can perform cell search, system information acquisition, beam alignment for initial access, and DL measurement on the basis of an SSB. The SSB is interchangeably used with a synchronization signal/physical broadcast channel (SS/PBCH) block.

The SSB includes a PSS, an SSS and a PBCH. The SSB is configured in four consecutive OFDM symbols, and a PSS, a PBCH, an SSS/PBCH or a PBCH is transmitted for each OFDM symbol. Each of the PSS and the SSS includes one OFDM symbol and 127 subcarriers, and the PBCH includes 3 OFDM symbols and 576 subcarriers.

Cell search refers to a process in which a UE acquires time/frequency synchronization of a cell and detects a cell identifier (ID) (e.g., physical layer cell ID (PCI)) of the cell. The PSS is used to detect a cell ID in a cell ID group and the SSS is used to detect a cell ID group. The PBCH is used to detect an SSB (time) index and a half-frame.

There are 336 cell ID groups and there are 3 cell IDs per cell ID group. A total of 1008 cell IDs are present. Information on a cell ID group to which a cell ID of a cell belongs is provided/acquired through an SSS of the cell, and information on the cell ID among 336 cell ID groups is provided/acquired through a PSS.

The SSB is periodically transmitted in accordance with SSB periodicity. A default SSB periodicity assumed by a UE during initial cell search is defined as 20 ms. After cell access, the SSB periodicity can be set to one of {5 ms, 10 ms, 20 ms, 40 ms, 80 ms, 160 ms} by a network (e.g., a BS).

Next, acquisition of system information (SI) will be described.

SI is divided into a master information block (MIB) and a plurality of system information blocks (SIBs). SI other than the MIB may be referred to as remaining minimum system information. The MIB includes information/parameter for monitoring a PDCCH that schedules a PDSCH carrying SIB1 (SystemInformationBlock1) and is transmitted by a BS through a PBCH of an SSB. SIB1 includes information related to availability and scheduling (e.g., transmission periodicity and SI-window size) of the remaining SIBs (hereinafter, SIBx, x is an integer equal to or greater than 2). SiBx is included in an SI message and transmitted over a PDSCH. Each SI message is transmitted within a periodically generated time window (i.e., SI-window).

A random access (RA) procedure in a 5G communication system will be additionally described with reference to FIG. 2.

A random access procedure is used for various purposes. For example, the random access procedure can be used for network initial access, handover, and UE-triggered UL data transmission. A UE can acquire UL synchronization and UL transmission resources through the random access procedure. The random access procedure is classified into a contention-based random access procedure and a contention-free random access procedure. A detailed procedure for the contention-based random access procedure is as follows.

A UE can transmit a random access preamble through a PRACH as Msg1 of a random access procedure in UL. Random access preamble sequences having different two lengths are supported. A long sequence length 839 is applied to subcarrier spacings of 1.25 kHz and 5 kHz and a short sequence length 139 is applied to subcarrier spacings of 15 kHz, 30 kHz, 60 kHz and 120 kHz.

When a BS receives the random access preamble from the UE, the BS transmits a random access response (RAR) message (Msg2) to the UE. A PDCCH that schedules a PDSCH carrying a RAR is CRC masked by a random access (RA) radio network temporary identifier (RNTI) (RA-RNTI) and transmitted. Upon detection of the PDCCH masked by the RA-RNTI, the UE can receive a RAR from the PDSCH scheduled by DCI carried by the PDCCH. The UE checks whether the RAR includes random access response information with respect to the preamble transmitted by the UE, that is, Msg1. Presence or absence of random access information with respect to Msg1 transmitted by the UE can be determined according to presence or absence of a random access preamble ID with respect to the preamble transmitted by the UE. If there is no response to Msg1, the UE can retransmit the RACH preamble less than a predetermined number of times while performing power ramping. The UE calculates PRACH transmission power for preamble retransmission on the basis of most recent pathloss and a power ramping counter.

The UE can perform UL transmission through Msg3 of the random access procedure over a physical uplink shared channel on the basis of the random access response information. Msg3 can include an RRC connection request and a UE ID. The network can transmit Msg4 as a response to Msg3, and Msg4 can be handled as a contention resolution message on DL. The UE can enter an RRC connected state by receiving Msg4.

C. Beam Management (BM) Procedure of 5G Communication System

A BM procedure can be divided into (1) a DL MB procedure using an SSB or a CSI-RS and (2) a UL BM procedure using a sounding reference signal (SRS). In addition, each BM procedure can include Tx beam swiping for determining a Tx beam and Rx beam swiping for determining an Rx beam.

The DL BM procedure using an SSB will be described.

Configuration of a beam report using an SSB is performed when channel state information (CSI)/beam is configured in RRC_CONNECTED.
A UE receives a CSI-ResourceConfig IE including CSI-SSB-ResourceSetList for SSB resources used for BM from a BS. The RRC parameter “csi-SSB-ResourceSetList” represents a list of SSB resources used for beam management and report in one resource set. Here, an SSB resource set can be set as {SSBx1, SSBx2, SSBx3, SSBx4, . . . }. An SSB index can be defined in the range of 0 to 63.
The UE receives the signals on SSB resources from the BS on the basis of the CSI-SSB-ResourceSetList.
When CSI-RS reportConfig with respect to a report on SSBRI and reference signal received power (RSRP) is set, the UE reports the best SSBRI and RSRP corresponding thereto to the BS. For example, when reportQuantity of the CSI-RS reportConfig IE is set to ‘ssb-Index-RSRP’, the UE reports the best SSBRI and RSRP corresponding thereto to the BS.

When a CSI-RS resource is configured in the same OFDM symbols as an SSB and ‘QCL-TypeD’ is applicable, the UE can assume that the CSI-RS and the SSB are quasi co-located (QCL) from the viewpoint of ‘QCL-TypeD’. Here, QCL-TypeD may mean that antenna ports are quasi co-located from the viewpoint of a spatial Rx parameter. When the UE receives signals of a plurality of DL antenna ports in a QCL-TypeD relationship, the same Rx beam can be applied.

Next, a DL BM procedure using a CSI-RS will be described.

An Rx beam determination (or refinement) procedure of a UE and a Tx beam swiping procedure of a BS using a CSI-RS will be sequentially described. A repetition parameter is set to ‘ON’ in the Rx beam determination procedure of a UE and set to ‘OFF’ in the Tx beam swiping procedure of a BS.

First, the Rx beam determination procedure of a UE will be described.
The UE receives an NZP CSI-RS resource set IE including an RRC parameter with respect to ‘repetition’ from a BS through RRC signaling. Here, the RRC parameter ‘repetition’ is set to ‘ON’.
The UE repeatedly receives signals on resources in a CSI-RS resource set in which the RRC parameter ‘repetition’ is set to ‘ON’ in different OFDM symbols through the same Tx beam (or DL spatial domain transmission filters) of the BS.
The UE determines an RX beam thereof.
The UE skips a CSI report. That is, the UE can skip a CSI report when the RRC parameter ‘repetition’ is set to ‘ON’.

Next, the Tx beam determination procedure of a BS will be described.
A UE receives an NZP CSI-RS resource set IE including an RRC parameter with respect to ‘repetition’ from the BS through RRC signaling. Here, the RRC parameter ‘repetition’ is related to the Tx beam swiping procedure of the BS when set to ‘OFF’.
The UE receives signals on resources in a CSI-RS resource set in which the RRC parameter ‘repetition’ is set to ‘OFF’ in different DL spatial domain transmission filters of the BS.
The UE selects (or determines) a best beam.
The UE reports an ID (e.g., CRI) of the selected beam and related quality information (e.g., RSRP) to the BS. That is, when a CSI-RS is transmitted for BM, the UE reports a CRI and RSRP with respect thereto to the BS.

Next, the UL BM procedure using an SRS will be described.
A UE receives RRC signaling (e.g., SRS-Config IE) including a (RRC parameter) purpose parameter set to ‘beam management” from a BS. The SRS-Config IE is used to set SRS transmission. The SRS-Config IE includes a list of SRS-Resources and a list of SRS-ResourceSets. Each SRS resource set refers to a set of SRS-resources.

The UE determines Tx beamforming for SRS resources to be transmitted on the basis of SRS-SpatialRelation Info included in the SRS-Config IE. Here, SRS-SpatialRelation Info is set for each SRS resource and indicates whether the same beamforming as that used for an SSB, a CSI-RS or an SRS will be applied for each SRS resource.
When SRS-SpatialRelationInfo is set for SRS resources, the same beamforming as that used for the SSB, CSI-RS or SRS is applied. However, when SRS-SpatialRelationlnfo is not set for SRS resources, the UE arbitrarily determines Tx beamforming and transmits an SRS through the determined Tx beamforming.

Next, a beam failure recovery (BFR) procedure will be described.

In a beamformed system, radio link failure (RLF) may frequently occur due to rotation, movement or beamforming blockage of a UE. Accordingly, NR supports BFR in order to prevent frequent occurrence of RLF. BFR is similar to a radio link failure recovery procedure and can be supported when a UE knows new candidate beams. For beam failure detection, a BS configures beam failure detection reference signals for a UE, and the UE declares beam failure when the number of beam failure indications from the physical layer of the UE reaches a threshold set through RRC signaling within a period set through RRC signaling of the BS. After beam failure detection, the UE triggers beam failure recovery by initiating a random access procedure in a PCell and performs beam failure recovery by selecting a suitable beam. (When the BS provides dedicated random access resources for certain beams, these are prioritized by the UE). Completion of the aforementioned random access procedure is regarded as completion of beam failure recovery.

D. URLLC (Ultra-Reliable and Low Latency Communication)

URLLC transmission defined in NR can refer to (1) a relatively low traffic size, (2) a relatively low arrival rate, (3) extremely low latency requirements (e.g., 0.5 and 1 ms), (4) relatively short transmission duration (e.g., 2 OFDM symbols), (5) urgent services/messages, etc. In the case of UL, transmission of traffic of a specific type (e.g., URLLC) needs to be multiplexed with another transmission (e.g., eMBB) scheduled in advance in order to satisfy more stringent latency requirements. In this regard, a method of providing information indicating preemption of specific resources to a UE scheduled in advance and allowing a URLLC UE to use the resources for UL transmission is provided.

NR supports dynamic resource sharing between eMBB and URLLC. eMBB and URLLC services can be scheduled on non-overlapping time/frequency resources, and URLLC transmission can occur in resources scheduled for ongoing eMBB traffic. An eMBB UE may not ascertain whether PDSCH transmission of the corresponding UE has been partially punctured and the UE may not decode a PDSCH due to corrupted coded bits. In view of this, NR provides a preemption indication. The preemption indication may also be referred to as an interrupted transmission indication.

With regard to the preemption indication, a UE receives DownlinkPreemption IE through RRC signaling from a BS. When the UE is provided with DownlinkPreemption IE, the UE is configured with INT-RNTI provided by a parameter int-RNTI in DownlinkPreemption IE for monitoring of a PDCCH that conveys DCI format 2_1. The UE is additionally configured with a corresponding set of positions for fields in DCI format 2_1 according to a set of serving cells and positionInDCl by INT-ConfigurationPerServing Cell including a set of serving cell indexes provided by servingCellID, configured having an information payload size for DCI format 2_1 according to dci-Payloadsize, and configured with indication granularity of time-frequency resources according to timeFrequencySect.

The UE receives DCI format 2_1 from the BS on the basis of the DownlinkPreemption IE.

When the UE detects DCI format 2_1 for a serving cell in a configured set of serving cells, the UE can assume that there is no transmission to the UE in PRBs and symbols indicated by the DCI format 2_1 in a set of PRBs and a set of symbols in a last monitoring period before a monitoring period to which the DCI format 2_1 belongs. For example, the UE assumes that a signal in a time-frequency resource indicated according to preemption is not DL transmission scheduled therefor and decodes data on the basis of signals received in the remaining resource region.

E. mMTC (Massive MTC)

mMTC (massive Machine Type Communication) is one of 5G scenarios for supporting a hyper-connection service providing simultaneous communication with a large number of UEs. In this environment, a UE intermittently performs communication with a very low speed and mobility. Accordingly, a main goal of mMTC is operating a UE for a long time at a low cost. With respect to mMTC, 3GPP deals with MTC and NB (NarrowBand)-IoT.

mMTC has features such as repetitive transmission of a PDCCH, a PUCCH, a PDSCH (physical downlink shared channel), a PUSCH, etc., frequency hopping, retuning, and a guard period.

That is, a PUSCH (or a PUCCH (particularly, a long PUCCH) or a PRACH) including specific information and a PDSCH (or a PDCCH) including a response to the specific information are repeatedly transmitted. Repetitive transmission is performed through frequency hopping, and for repetitive transmission, (RF) retuning from a first frequency resource to a second frequency resource is performed in a guard period and the specific information and the response to the specific information can be transmitted/received through a narrowband (e.g., 6 resource blocks (RBs) or 1 RB).

F. Basic Operation Between Autonomous Vehicles using 5G Communication

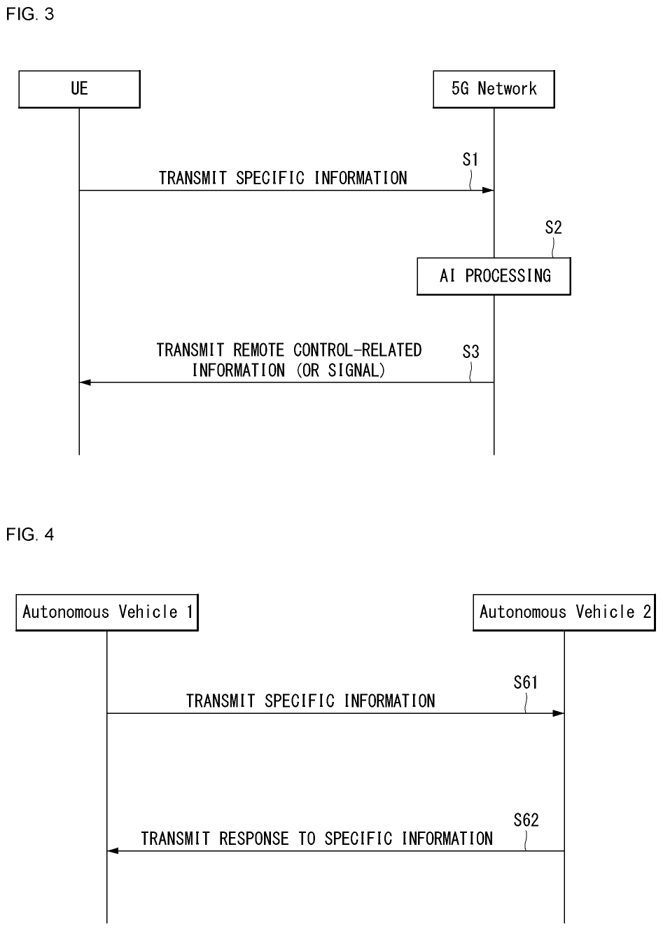

FIG. 3 shows an example of basic operations of an autonomous vehicle and a 5G network in a 5G communication system.

The autonomous vehicle transmits specific information to the 5G network (S1). The specific information may include autonomous driving related information. In addition, the 5G network can determine whether to remotely control the vehicle (S2). Here, the 5G network may include a server or a module which performs remote control related to autonomous driving. In addition, the 5G network can transmit information (or signal) related to remote control to the autonomous vehicle (S3).

G. Applied Operations Between Autonomous Vehicle and 5G Network in 5G Communication System

Hereinafter, the operation of an autonomous vehicle using 5G communication will be described in more detail with reference to wireless communication technology (BM procedure, URLLC, mMTC, etc.) described in FIGS. 1 and 2.

First, a basic procedure of an applied operation to which a method proposed by the present invention which will be described later and eMBB of 5G communication are applied will be described.

As in steps S1 and S3 of FIG. 3, the autonomous vehicle performs an initial access procedure and a random access procedure with the 5G network prior to step S1 of FIG. 3 in order to transmit/receive signals, information and the like to/from the 5G network.

More specifically, the autonomous vehicle performs an initial access procedure with the 5G network on the basis of an SSB in order to acquire DL synchronization and system information. A beam management (BM) procedure and a beam failure recovery procedure may be added in the initial access procedure, and quasi-co-location (QCL) relation may be added in a process in which the autonomous vehicle receives a signal from the 5G network.

In addition, the autonomous vehicle performs a random access procedure with the 5G network for UL synchronization acquisition and/or UL transmission. The 5G network can transmit, to the autonomous vehicle, a UL grant for scheduling transmission of specific information. Accordingly, the autonomous vehicle transmits the specific information to the 5G network on the basis of the UL grant. In addition, the 5G network transmits, to the autonomous vehicle, a DL grant for scheduling transmission of 5G processing results with respect to the specific information. Accordingly, the 5G network can transmit, to the autonomous vehicle, information (or a signal) related to remote control on the basis of the DL grant.

Next, a basic procedure of an applied operation to which a method proposed by the present invention which will be described later and URLLC of 5G communication are applied will be described.

As described above, an autonomous vehicle can receive DownlinkPreemption IE from the 5G network after the autonomous vehicle performs an initial access procedure and/or a random access procedure with the 5G network. Then, the autonomous vehicle receives DCI format 2_1 including a preemption indication from the 5G network on the basis of DownlinkPreemption IE. The autonomous vehicle does not perform (or expect or assume) reception of eMBB data in resources (PRBs and/or OFDM symbols) indicated by the preemption indication. Thereafter, when the autonomous vehicle needs to transmit specific information, the autonomous vehicle can receive a UL grant from the 5G network.

Next, a basic procedure of an applied operation to which a method proposed by the present invention which will be described later and mMTC of 5G communication are applied will be described.

Description will focus on parts in the steps of FIG. 3 which are changed according to application of mMTC.

In step S1 of FIG. 3, the autonomous vehicle receives a UL grant from the 5G network in order to transmit specific information to the 5G network. Here, the UL grant may include information on the number of repetitions of transmission of the specific information and the specific information may be repeatedly transmitted on the basis of the information on the number of repetitions. That is, the autonomous vehicle transmits the specific information to the 5G network on the basis of the UL grant. Repetitive transmission of the specific information may be performed through frequency hopping, the first transmission of the specific information may be performed in a first frequency resource, and the second transmission of the specific information may be performed in a second frequency resource. The specific information can be transmitted through a narrowband of 6 resource blocks (RBs) or 1 RB.

H. Autonomous Driving Operation between Vehicles using 5G Communication

FIG. 4 shows an example of a basic operation between vehicles using 5G communication.

A first vehicle transmits specific information to a second vehicle (S61). The second vehicle transmits a response to the specific information to the first vehicle (S62).

Meanwhile, a configuration of an applied operation between vehicles may depend on whether the 5G network is directly (sidelink communication transmission mode 3) or indirectly (sidelink communication transmission mode 4) involved in resource allocation for the specific information and the response to the specific information.

Next, an applied operation between vehicles using 5G communication will be described.

First, a method in which a 5G network is directly involved in resource allocation for signal transmission/reception between vehicles will be described.

The 5G network can transmit DCI format 5A to the first vehicle for scheduling of mode-3 transmission (PSCCH and/or PSSCH transmission). Here, a physical sidelink control channel (PSCCH) is a 5G physical channel for scheduling of transmission of specific information a physical sidelink shared channel (PSSCH) is a 5G physical channel for transmission of specific information. In addition, the first vehicle transmits SCI format 1 for scheduling of specific information transmission to the second vehicle over a PSCCH. Then, the first vehicle transmits the specific information to the second vehicle over a PSSCH.

Next, a method in which a 5G network is indirectly involved in resource allocation for signal transmission/reception will be described.

The first vehicle senses resources for mode-4 transmission in a first window. Then, the first vehicle selects resources for mode-4 transmission in a second window on the basis of the sensing result. Here, the first window refers to a sensing window and the second window refers to a selection window. The first vehicle transmits SCI format 1 for scheduling of transmission of specific information to the second vehicle over a PSCCH on the basis of the selected resources. Then, the first vehicle transmits the specific information to the second vehicle over a PSSCH.

The above-described 5G communication technology can be combined with methods proposed in the present invention which will be described later and applied or can complement the methods proposed in the present invention to make technical features of the methods concrete and clear.

Driving

(1) Exterior of Vehicle

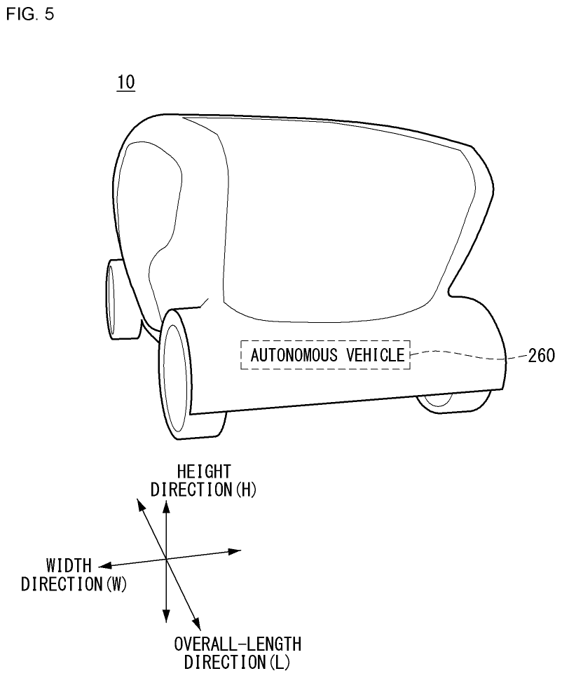

FIG. 5 is a diagram showing a vehicle according to an embodiment of the present invention.

Referring to FIG. 5, a vehicle 10 according to an embodiment of the present invention is defined as a transportation means traveling on roads or railroads. The vehicle 10 includes a car, a train and a motorcycle. The vehicle 10 may include an internal-combustion engine vehicle having an engine as a power source, a hybrid vehicle having an engine and a motor as a power source, and an electric vehicle having an electric motor as a power source. The vehicle 10 may be a private own vehicle. The vehicle 10 may be a shared vehicle. The vehicle 10 may be an autonomous vehicle.

(2) Components of Vehicle

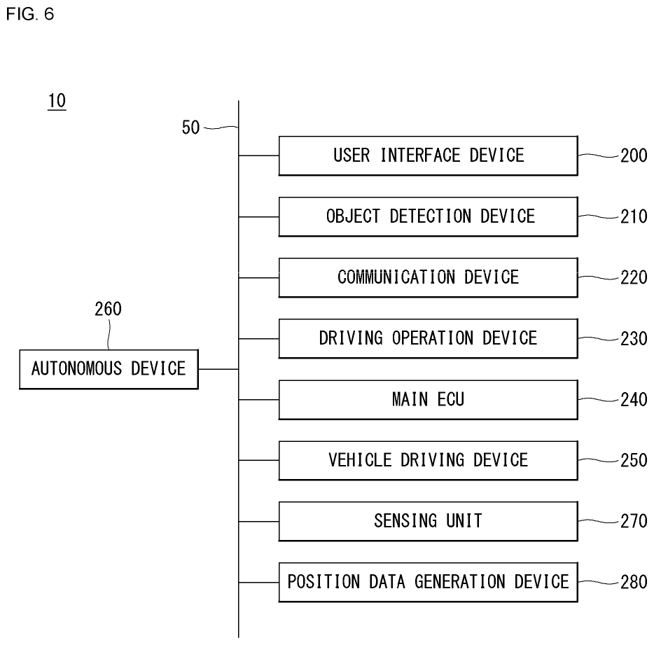

FIG. 6 is a control block diagram of the vehicle according to an embodiment of the present invention.

Referring to FIG. 6, the vehicle 10 may include a user interface device 200, an object detection device 210, a communication device 220, a driving operation device 230, a main ECU 240, a driving control device 250, an autonomous device 260, a sensing unit 270, and a position data generation device 280. The object detection device 210, the communication device 220, the driving operation device 230, the main ECU 240, the driving control device 250, the autonomous device 260, the sensing unit 270 and the position data generation device 280 may be realized by electronic devices which generate electric signals and exchange the electric signals from one another.

1) User Interface Device

The user interface device 200 is a device for communication between the vehicle 10 and a user. The user interface device 200 can receive user input and provide information generated in the vehicle 10 to the user. The vehicle 10 can realize a user interface (UI) or user experience (UX) through the user interface device 200. The user interface device 200 may include an input device, an output device and a user monitoring device.

2) Object Detection Device

The object detection device 210 can generate information about objects outside the vehicle 10. Information about an object can include at least one of information on presence or absence of the object, positional information of the object, information on a distance between the vehicle 10 and the object, and information on a relative speed of the vehicle 10 with respect to the object. The object detection device 210 can detect objects outside the vehicle 10. The object detection device 210 may include at least one sensor which can detect objects outside the vehicle 10. The object detection device 210 may include at least one of a camera, a radar, a lidar, an ultrasonic sensor and an infrared sensor. The object detection device 210 can provide data about an object generated on the basis of a sensing signal generated from a sensor to at least one electronic device included in the vehicle.

2.1) Camera

The camera can generate information about objects outside the vehicle 10 using images. The camera may include at least one lens, at least one image sensor, and at least one processor which is electrically connected to the image sensor, processes received signals and generates data about objects on the basis of the processed signals.

The camera may be at least one of a mono camera, a stereo camera and an around view monitoring (AVM) camera. The camera can acquire positional information of objects, information on distances to objects, or information on relative speeds with respect to objects using various image processing algorithms. For example, the camera can acquire information on a distance to an object and information on a relative speed with respect to the object from an acquired image on the basis of change in the size of the object over time. For example, the camera may acquire information on a distance to an object and information on a relative speed with respect to the object through a pin-hole model, road profiling, or the like. For example, the camera may acquire information on a distance to an object and information on a relative speed with respect to the object from a stereo image acquired from a stereo camera on the basis of disparity information.

The camera may be attached at a portion of the vehicle at which FOV (field of view) can be secured in order to photograph the outside of the vehicle. The camera may be disposed in proximity to the front windshield inside the vehicle in order to acquire front view images of the vehicle. The camera may be disposed near a front bumper or a radiator grill. The camera may be disposed in proximity to a rear glass inside the vehicle in order to acquire rear view images of the vehicle. The camera may be disposed near a rear bumper, a trunk or a tail gate. The camera may be disposed in proximity to at least one of side windows inside the vehicle in order to acquire side view images of the vehicle. Alternatively, the camera may be disposed near a side mirror, a fender or a door.

2.2) Radar

The radar can generate information about an object outside the vehicle using electromagnetic waves. The radar may include an electromagnetic wave transmitter, an electromagnetic wave receiver, and at least one processor which is electrically connected to the electromagnetic wave transmitter and the electromagnetic wave receiver, processes received signals and generates data about an object on the basis of the processed signals. The radar may be realized as a pulse radar or a continuous wave radar in terms of electromagnetic wave emission. The continuous wave radar may be realized as a frequency modulated continuous wave (FMCW) radar or a frequency shift keying (FSK) radar according to signal waveform. The radar can detect an object through electromagnetic waves on the basis of TOF (Time of Flight) or phase shift and detect the position of the detected object, a distance to the detected object and a relative speed with respect to the detected object. The radar may be disposed at an appropriate position outside the vehicle in order to detect objects positioned in front of, behind or on the side of the vehicle.

2.3 Lidar

The lidar can generate information about an object outside the vehicle 10 using a laser beam. The lidar may include a light transmitter, a light receiver, and at least one processor which is electrically connected to the light transmitter and the light receiver, processes received signals and generates data about an object on the basis of the processed signal. The lidar may be realized according to TOF or phase shift. The lidar may be realized as a driven type or a non-driven type. A driven type lidar may be rotated by a motor and detect an object around the vehicle 10. A non-driven type lidar may detect an object positioned within a predetermined range from the vehicle according to light steering. The vehicle 10 may include a plurality of non-drive type lidars. The lidar can detect an object through a laser beam on the basis of TOF (Time of Flight) or phase shift and detect the position of the detected object, a distance to the detected object and a relative speed with respect to the detected object. The lidar may be disposed at an appropriate position outside the vehicle in order to detect objects positioned in front of, behind or on the side of the vehicle.

3) Communication Device

The communication device 220 can exchange signals with devices disposed outside the vehicle 10. The communication device 220 can exchange signals with at least one of infrastructure (e.g., a server and a broadcast station), another vehicle and a terminal. The communication device 220 may include a transmission antenna, a reception antenna, and at least one of a radio frequency (RF) circuit and an RF element which can implement various communication protocols in order to perform communication.

For example, the communication device can exchange signals with external devices on the basis of C-V2X (Cellular V2X). For example, C-V2X can include sidelink communication based on LTE and/or sidelink communication based on NR. Details related to C-V2X will be described later.

For example, the communication device can exchange signals with external devices on the basis of DSRC (Dedicated Short Range Communications) or WAVE (Wireless Access in Vehicular Environment) standards based on IEEE 802.11p PHY/MAC layer technology and IEEE 1609 Network/Transport layer technology. DSRC (or WAVE standards) is communication specifications for providing an intelligent transport system (ITS) service through short-range dedicated communication between vehicle-mounted devices or between a roadside device and a vehicle-mounted device. DSRC may be a communication scheme that can use a frequency of 5.9 GHz and have a data transfer rate in the range of 3 Mbps to 27 Mbps. IEEE 802.11p may be combined with IEEE 1609 to support DSRC (or WAVE standards).

The communication device of the present invention can exchange signals with external devices using only one of C-V2X and DSRC. Alternatively, the communication device of the present invention can exchange signals with external devices using a hybrid of C-V2X and DSRC.

4) Driving Operation Device

The driving operation device 230 is a device for receiving user input for driving. In a manual mode, the vehicle 10 may be driven on the basis of a signal provided by the driving operation device 230. The driving operation device 230 may include a steering input device (e.g., a steering wheel), an acceleration input device (e.g., an acceleration pedal) and a brake input device (e.g., a brake pedal).

5) Main ECU

The main ECU 240 can control the overall operation of at least one electronic device included in the vehicle 10.

6) Driving Control Device

The driving control device 250 is a device for electrically controlling various vehicle driving devices included in the vehicle 10. The driving control device 250 may include a power train driving control device, a chassis driving control device, a door/window driving control device, a safety device driving control device, a lamp driving control device, and an air-conditioner driving control device. The power train driving control device may include a power source driving control device and a transmission driving control device. The chassis driving control device may include a steering driving control device, a brake driving control device and a suspension driving control device. Meanwhile, the safety device driving control device may include a seat belt driving control device for seat belt control.

The driving control device 250 includes at least one electronic control device (e.g., a control ECU (Electronic Control Unit)).

The driving control device 250 can control vehicle driving devices on the basis of signals received by the autonomous device 260. For example, the driving control device 250 can control a power train, a steering device and a brake device on the basis of signals received by the autonomous device 260.

7) Autonomous Device

The autonomous device 260 can generate a route for self-driving on the basis of acquired data. The autonomous device 260 can generate a driving plan for traveling along the generated route. The autonomous device 260 can generate a signal for controlling movement of the vehicle according to the driving plan. The autonomous device 260 can provide the signal to the driving control device 250.

The autonomous device 260 can implement at least one ADAS (Advanced Driver Assistance System) function. The ADAS can implement at least one of ACC (Adaptive Cruise Control), AEB (Autonomous Emergency Braking), FCW (Forward Collision Warning), LKA (Lane Keeping Assist), LCA (Lane Change Assist), TFA (Target Following Assist), BSD (Blind Spot Detection), HBA (High Beam Assist), APS (Auto Parking System), a PD collision warning system, TSR (Traffic Sign Recognition), TSA (Traffic Sign Assist), NV (Night Vision), DSM (Driver Status Monitoring) and TJA (Traffic Jam Assist).

The autonomous device 260 can perform switching from a self-driving mode to a manual driving mode or switching from the manual driving mode to the self-driving mode. For example, the autonomous device 260 can switch the mode of the vehicle 10 from the self-driving mode to the manual driving mode or from the manual driving mode to the self-driving mode on the basis of a signal received from the user interface device 200.

8) Sensing Unit

The sensing unit 270 can detect a state of the vehicle. The sensing unit 270 may include at least one of an internal measurement unit (IMU) sensor, a collision sensor, a wheel sensor, a speed sensor, an inclination sensor, a weight sensor, a heading sensor, a position module, a vehicle forward/backward movement sensor, a battery sensor, a fuel sensor, a tire sensor, a steering sensor, a temperature sensor, a humidity sensor, an ultrasonic sensor, an illumination sensor, and a pedal position sensor. Further, the IMU sensor may include one or more of an acceleration sensor, a gyro sensor and a magnetic sensor.

The sensing unit 270 can generate vehicle state data on the basis of a signal generated from at least one sensor. Vehicle state data may be information generated on the basis of data detected by various sensors included in the vehicle. The sensing unit 270 may generate vehicle attitude data, vehicle motion data, vehicle yaw data, vehicle roll data, vehicle pitch data, vehicle collision data, vehicle orientation data, vehicle angle data, vehicle speed data, vehicle acceleration data, vehicle tilt data, vehicle forward/backward movement data, vehicle weight data, battery data, fuel data, tire pressure data, vehicle internal temperature data, vehicle internal humidity data, steering wheel rotation angle data, vehicle external illumination data, data of a pressure applied to an acceleration pedal, data of a pressure applied to a brake panel, etc.

9) Position Data Generation Device

The position data generation device 280 can generate position data of the vehicle 10. The position data generation device 280 may include at least one of a global positioning system (GPS) and a differential global positioning system (DGPS). The position data generation device 280 can generate position data of the vehicle 10 on the basis of a signal generated from at least one of the GPS and the DGPS. According to an embodiment, the position data generation device 280 can correct position data on the basis of at least one of the inertial measurement unit (IMU) sensor of the sensing unit 270 and the camera of the object detection device 210. The position data generation device 280 may also be called a global navigation satellite system (GNSS).

The vehicle 10 may include an internal communication system 50. The plurality of electronic devices included in the vehicle 10 can exchange signals through the internal communication system 50. The signals may include data. The internal communication system 50 can use at least one communication protocol (e.g., CAN, LIN, FlexRay, MOST or Ethernet).

(3) Components of Autonomous Device

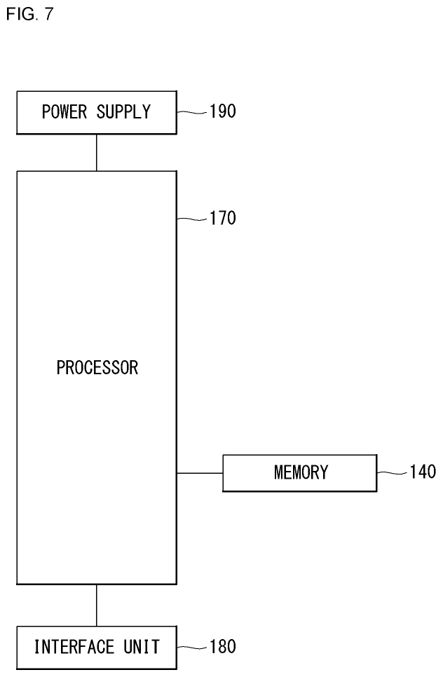

FIG. 7 is a control block diagram of the autonomous device according to an embodiment of the present invention.

Referring to FIG. 7, the autonomous device 260 may include a memory 140, a processor 170, an interface 180 and a power supply 190.

The memory 140 is electrically connected to the processor 170. The memory 140 can store basic data with respect to units, control data for operation control of units, and input/output data. The memory 140 can store data processed in the processor 170. Hardware-wise, the memory 140 can be configured as at least one of a ROM, a RAM, an EPROM, a flash drive and a hard drive. The memory 140 can store various types of data for overall operation of the autonomous device 260, such as a program for processing or control of the processor 170. The memory 140 may be integrated with the processor 170. According to an embodiment, the memory 140 may be categorized as a subcomponent of the processor 170.

The interface 180 can exchange signals with at least one electronic device included in the vehicle 10 in a wired or wireless manner. The interface 180 can exchange signals with at least one of the object detection device 210, the communication device 220, the driving operation device 230, the main ECU 240, the driving control device 250, the sensing unit 270 and the position data generation device 280 in a wired or wireless manner. The interface 180 can be configured using at least one of a communication module, a terminal, a pin, a cable, a port, a circuit, an element and a device.

The power supply 190 can provide power to the autonomous device 260. The power supply 190 can be provided with power from a power source (e.g., a battery) included in the vehicle 10 and supply the power to each unit of the autonomous device 260. The power supply 190 can operate according to a control signal supplied from the main ECU 240. The power supply 190 may include a switched-mode power supply (SM PS).

The processor 170 can be electrically connected to the memory 140, the interface 180 and the power supply 190 and exchange signals with these components. The processor 170 can be realized using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and electronic units for executing other functions.

The processor 170 can be operated by power supplied from the power supply 190. The processor 170 can receive data, process the data, generate a signal and provide the signal while power is supplied thereto.

The processor 170 can receive information from other electronic devices included in the vehicle 10 through the interface 180. The processor 170 can provide control signals to other electronic devices in the vehicle 10 through the interface 180.

The autonomous device 260 may include at least one printed circuit board (PCB). The memory 140, the interface 180, the power supply 190 and the processor 170 may be electrically connected to the PCB.

(4) Operation of Autonomous Device

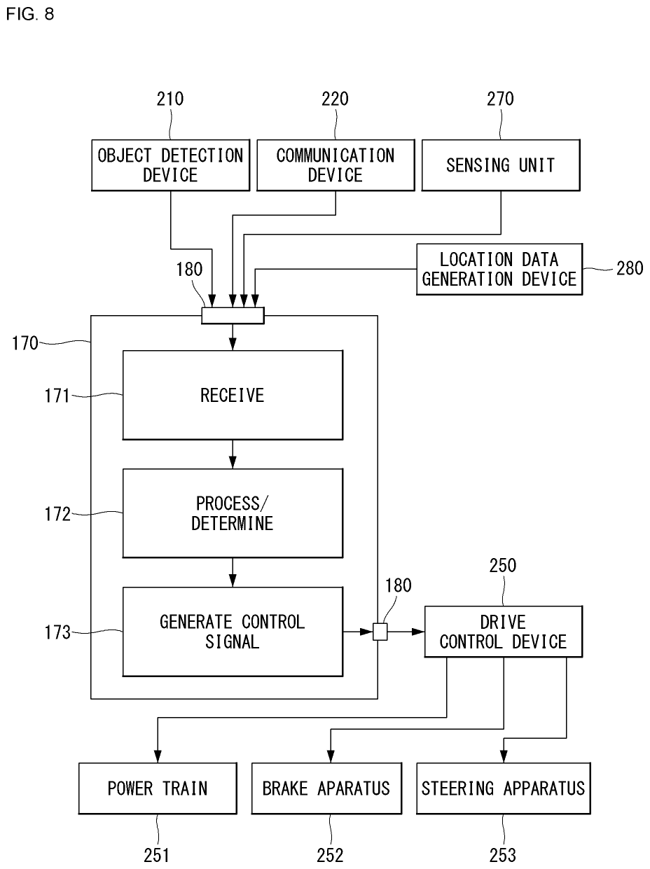

FIG. 8 is a diagram showing a signal flow in an autonomous vehicle according to an embodiment of the present invention.

1) Reception Operation

Referring to FIG. 8, the processor 170 can perform a reception operation.

The processor 170 can receive data from at least one of the object detection device 210, the communication device 220, the sensing unit 270 and the position data generation device 280 through the interface 180. The processor 170 can receive object data from the object detection device 210. The processor 170 can receive HD map data from the communication device 220. The processor 170 can receive vehicle state data from the sensing unit 270. The processor 170 can receive position data from the position data generation device 280.

2) Processing/Determination Operation

The processor 170 can perform a processing/determination operation. The processor 170 can perform the processing/determination operation on the basis of traveling situation information. The processor 170 can perform the processing/determination operation on the basis of at least one of object data, HD map data, vehicle state data and position data.

2.1) Driving Plan Data Generation Operation

The processor 170 can generate driving plan data. For example, the processor 170 may generate electronic horizon data. The electronic horizon data can be understood as driving plan data in a range from a position at which the vehicle 10 is located to a horizon. The horizon can be understood as a point a predetermined distance before the position at which the vehicle 10 is located on the basis of a predetermined traveling route. The horizon may refer to a point at which the vehicle can arrive after a predetermined time from the position at which the vehicle 10 is located along a predetermined traveling route.

The electronic horizon data can include horizon map data and horizon path data.

2.1.1) Horizon Map Data

The horizon map data may include at least one of topology data, road data, HD map data and dynamic data. According to an embodiment, the horizon map data may include a plurality of layers. For example, the horizon map data may include a first layer that matches the topology data, a second layer that matches the road data, a third layer that matches the HD map data, and a fourth layer that matches the dynamic data. The horizon map data may further include static object data.

The topology data may be explained as a map created by connecting road centers. The topology data is suitable for approximate display of a location of a vehicle and may have a data form used for navigation for drivers. The topology data may be understood as data about road information other than information on driveways. The topology data may be generated on the basis of data received from an external server through the communication device 220. The topology data may be based on data stored in at least one memory included in the vehicle 10.

The road data may include at least one of road slope data, road curvature data and road speed limit data. The road data may further include no-passing zone data. The road data may be based on data received from an external server through the communication device 220. The road data may be based on data generated in the object detection device 210.

The HD map data may include detailed topology information in units of lanes of roads, connection information of each lane, and feature information for vehicle localization (e.g., traffic signs, lane marking/attribute, road furniture, etc.). The HD map data may be based on data received from an external server through the communication device 220.

The dynamic data may include various types of dynamic information which can be generated on roads. For example, the dynamic data may include construction information, variable speed road information, road condition information, traffic information, moving object information, etc. The dynamic data may be based on data received from an external server through the communication device 220. The dynamic data may be based on data generated in the object detection device 210.

The processor 170 can provide map data in a range from a position at which the vehicle 10 is located to the horizon.

2.1.2) Horizon Path Data

The horizon path data may be explained as a trajectory through which the vehicle 10 can travel in a range from a position at which the vehicle 10 is located to the horizon. The horizon path data may include data indicating a relative probability of selecting a road at a decision point (e.g., a fork, a junction, a crossroad, or the like). The relative probability may be calculated on the basis of a time taken to arrive at a final destination. For example, if a time taken to arrive at a final destination is shorter when a first road is selected at a decision point than that when a second road is selected, a probability of selecting the first road can be calculated to be higher than a probability of selecting the second road.

The horizon path data can include a main path and a sub-path. The main path may be understood as a trajectory obtained by connecting roads having a high relative probability of being selected. The sub-path can be branched from at least one decision point on the main path. The sub-path may be understood as a trajectory obtained by connecting at least one road having a low relative probability of being selected at at least one decision point on the main path.

3) Control Signal Generation Operation

The processor 170 can perform a control signal generation operation. The processor 170 can generate a control signal on the basis of the electronic horizon data.

For example, the processor 170 may generate at least one of a power train control signal, a brake device control signal and a steering device control signal on the basis of the electronic horizon data.

The processor 170 can transmit the generated control signal to the driving control device 250 through the interface 180. The driving control device 250 can transmit the control signal to at least one of a power train 251, a brake device 252 and a steering device 254.

Utonomous Vehicle Usage Scenarios

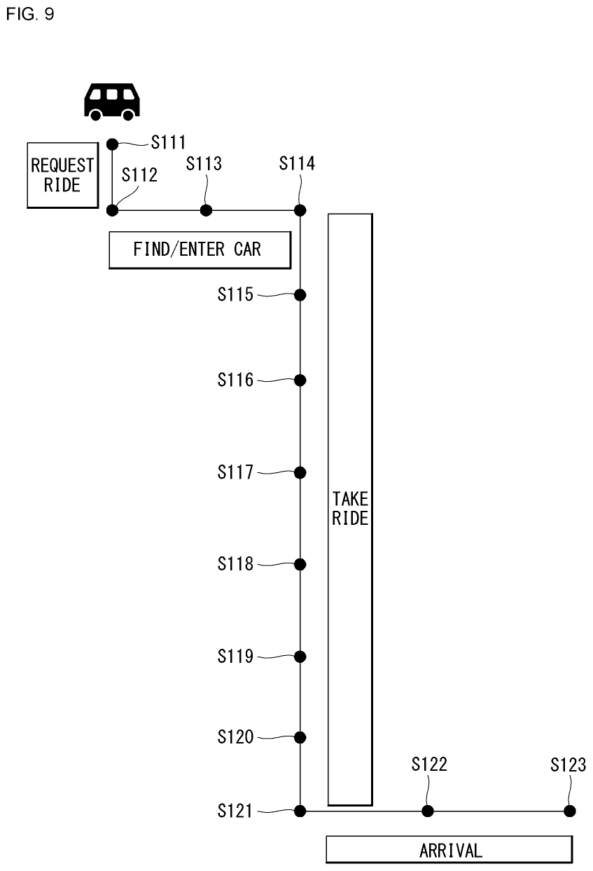

FIG. 9 is a diagram referred to in description of a usage scenario of a user according to an embodiment of the present invention.

1) Destination Prediction Scenario

A first scenario S111 is a scenario for prediction of a destination of a user. An application which can operate in connection with the cabin system 300 can be installed in a user terminal. The user terminal can predict a destination of a user on the basis of user's contextual information through the application. The user terminal can provide information on unoccupied seats in the cabin through the application.

2) Cabin Interior Layout Preparation Scenario

A second scenario S112 is a cabin interior layout preparation scenario. The cabin system 300 may further include a scanning device for acquiring data about a user located outside the vehicle. The scanning device can scan a user to acquire body data and baggage data of the user. The body data and baggage data of the user can be used to set a layout. The body data of the user can be used for user authentication. The scanning device may include at least one image sensor. The image sensor can acquire a user image using light of the visible band or infrared band.

The seat system 360 can set a cabin interior layout on the basis of at least one of the body data and baggage data of the user. For example, the seat system 360 may provide a baggage compartment or a car seat installation space.

3) User Welcome Scenario

A third scenario S113 is a user welcome scenario. The cabin system 300 may further include at least one guide light. The guide light can be disposed on the floor of the cabin. When a user riding in the vehicle is detected, the cabin system 300 can turn on the guide light such that the user sits on a predetermined seat among a plurality of seats. For example, the main controller 370 may realize a moving light by sequentially turning on a plurality of light sources over time from an open door to a predetermined user seat.

4) Seat Adjustment Service Scenario

A fourth scenario S114 is a seat adjustment service scenario. The seat system 360 can adjust at least one element of a seat that matches a user on the basis of acquired body information.

5) Personal Content Provision Scenario

A fifth scenario S115 is a personal content provision scenario. The display system 350 can receive user personal data through the input device 310 or the communication device 330. The display system 350 can provide content corresponding to the user personal data.

6) Item Provision Scenario

A sixth scenario S116 is an item provision scenario. The cargo system 355 can receive user data through the input device 310 or the communication device 330. The user data may include user preference data, user destination data, etc. The cargo system 355 can provide items on the basis of the user data.

7) Payment Scenario

A seventh scenario S117 is a payment scenario. The payment system 365 can receive data for price calculation from at least one of the input device 310, the communication device 330 and the cargo system 355. The payment system 365 can calculate a price for use of the vehicle by the user on the basis of the received data. The payment system 365 can request payment of the calculated price from the user (e.g., a mobile terminal of the user).

8) Display System Control Scenario of User

An eighth scenario S118 is a display system control scenario of a user. The input device 310 can receive a user input having at least one form and convert the user input into an electrical signal. The display system 350 can control displayed content on the basis of the electrical signal.

9) AI Agent Scenario

A ninth scenario S119 is a multi-channel artificial intelligence (AI) agent scenario for a plurality of users. The Al agent 372 can discriminate user inputs from a plurality of users. The AI agent 372 can control at least one of the display system 350, the cargo system 355, the seat system 360 and the payment system 365 on the basis of electrical signals obtained by converting user inputs from a plurality of users.

10) Multimedia Content Provision Scenario for Multiple Users

A tenth scenario S120 is a multimedia content provision scenario for a plurality of users. The display system 350 can provide content that can be viewed by all users together. In this case, the display system 350 can individually provide the same sound to a plurality of users through speakers provided for respective seats. The display system 350 can provide content that can be individually viewed by a plurality of users. In this case, the display system 350 can provide individual sound through a speaker provided for each seat.

11) User Safety Secure Scenario

An eleventh scenario S121 is a user safety secure scenario. When information on an object around the vehicle which threatens a user is acquired, the main controller 370 can control an alarm with respect to the object around the vehicle to be output through the display system 350.

12) Personal Belongings Loss Prevention Scenario

A twelfth scenario S122 is a user's belongings loss prevention scenario. The main controller 370 can acquire data about user's belongings through the input device 310. The main controller 370 can acquire user motion data through the input device 310. The main controller 370 can determine whether the user exits the vehicle leaving the belongings in the vehicle on the basis of the data about the belongings and the motion data. The main controller 370 can control an alarm with respect to the belongings to be output through the display system 350.

13) Alighting report scenario

A thirteenth scenario S123 is an alighting report scenario. The main controller 370 can receive alighting data of a user through the input device 310. After the user exits the vehicle, the main controller 370 can provide report data according to alighting to a mobile terminal of the user through the communication device 330. The report data can include data about a total charge for using the vehicle 10.

V2X (Vehicle-to-Everything)

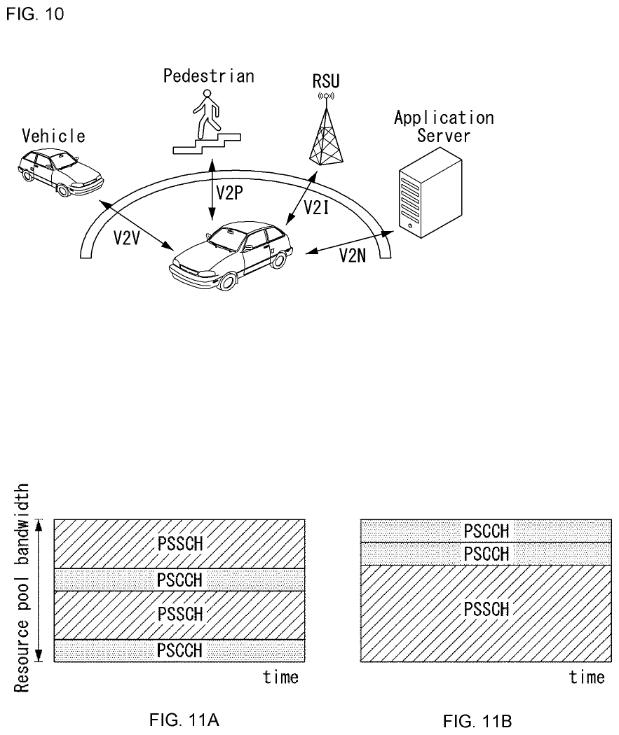

FIG. 10 illustrates V2X communication to which the present invention is applicable.

V2X communication includes communication between a vehicle and any entity, such as V2V (Vehicle-to-Vehicle) referring to communication between vehicles, V2I (Vehicle to Infrastructure) referring to communication between a vehicle and an eNB or a road side unit (RSU), V (Vehicle-to-Pedestrian) referring to communication between a vehicle and a UE carried by a person (a pedestrian, a bicycle driver, or a vehicle driver or passenger), and V2N (vehicle-to-network).

V2X communication may refer to the same meaning as V2X sidelink or NR V2X or refer to a wider meaning including V2X sidelink or NR V2X.

V2X communication is applicable to various services such as forward collision warning, automated parking system, cooperative adaptive cruise control (CACC), control loss warning, traffic line warning, vehicle vulnerable safety warning, emergency vehicle warning, curved road traveling speed warning, and traffic flow control.

V2X communication can be provided through a PC5 interface and/or a Uu interface. In this case, specific network entities for supporting communication between vehicles and every entity can be present in wireless communication systems supporting V2X communication. For example, the network entities may be a BS (eNB), a road side unit (RSU), a UE, an application server (e.g., traffic safety server) and the like.

Further, a UE which performs V2X communication may refer to a vehicle UE (V-UE), a pedestrian UE, a BS type (eNB type) RSU, a UE type RSU and a robot including a communication module as well as a handheld UE.

V2X communication can be directly performed between UEs or performed through the network entities. V2X operation modes can be categorized according to V2X communication execution methods.

V2X communication is required to support pseudonymity and privacy of UEs when a V2X application is used such that an operator or a third party cannot track a UE identifier within an area in which V2X is supported.

The terms frequently used in V2X communication are defined as follows.
RSU (Road Side Unit): RSU is a V2X service enabled device which can perform transmission/reception to/from moving vehicles using a V2I service. In addition, the RSU is a fixed infrastructure entity supporting a V2X application and can exchange messages with other entities supporting the V2X application. The RSU is a term frequently used in conventional ITS specifications and is introduced to 3GPP specifications in order to allow documents to be able to be read more easily in ITS industry. The RSU is a logical entity which combines V2X application logic with the function of a BS (BS-type RSU) or a UE (UE-type RSU).
V2I service: A type of V2X service having a vehicle as one side and an entity belonging to infrastructures as the other side.
V service: A type of V2X service having a vehicle as one side and a device carried by a person (e.g., a pedestrian, a bicycle rider, a driver or a handheld UE device carried by a fellow passenger) as the other side.
V2X service: A 3GPP communication service type related to a device performing transmission/reception to/from a vehicle.
V2X enabled UE: UE supporting V2X service.
V2V service: A V2X service type having vehicles as both sides.
V2V communication range: A range of direct communication between two vehicles participating in V2V service.

V2X applications called V2X (Vehicle-to-Everything) include four types of (1) vehicle-to-vehicle (V2V), (2) vehicle-to-infrastructure (V2I), (3) vehicle-to-network (V2N) and (4) vehicle-to-pedestrian (V) as described above.

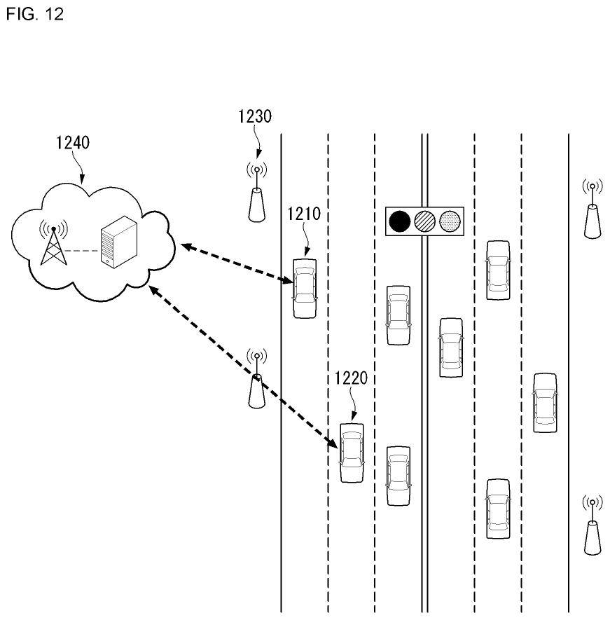

FIGS. 11A and 11B illustrate a resource allocation method in siderink in which V2X is used.

On sidelink, different physical sidelink control channels (PSCCHs) may be spaced and allocated in the frequency domain and different physical sidelink shared channels (PSSCHs) may be spaced and allocated. Alternatively, different PSCCHs may be continuously allocated in the frequency domain and PSSCHs may also be continuously allocated in the frequency domain.

NR V2X

To extend 3GPP platform to auto industry during 3GPP release 14 and 15, support for V2V and V2X services has been introduced in LTE.

Requirements for support for enhanced V2X use cases are arranged into four use example groups.

(1) Vehicle platooning enables dynamic formation of a platoon in which vehicles move together. All vehicles in a platoon obtain information from the leading vehicle in order to manage the platoon. Such information allows vehicles to travel in harmony rather than traveling in a normal direction and to move together in the same direction.

(2) Extended sensors allow vehicles, road side units, pedestrian devices and V2X application servers to exchange raw data or processed data collected through local sensors or live video images. A vehicle can enhance recognition of environment beyond a level that can be detected by a sensor thereof and can ascertain local circumstances more extensively and generally. A high data transfer rate is one of major characteristics.

(3) Advanced driving enables semi-automatic or full-automatic driving. Each vehicle and/or RSU share data recognized thereby and obtained from local sensors with a neighboring vehicle, and a vehicle can synchronize and adjust a trajectory or maneuver. Each vehicle shares driving intention with a neighboring traveling vehicle.

(4) Remote driving enables a remote driver or a V2X application to drive a remote vehicle for a passenger who cannot drive or cannot drive a remote vehicle in a dangerous environment. When changes are limited and routes can be predicted such as public transportation, driving based on cloud computing can be used. High reliability and low latency time are major requirements.

The above-described 5G communication technology may be applied in combination with the methods proposed in the present invention to be described later, or may be supplemented to specify or clarify the technical features of the methods proposed in the present invention.

Hereinafter, a method and apparatus for charging a battery of a driving vehicle in an autonomous driving system according to an embodiment of the present invention will be described.

In general, in order to charge a battery of an electric vehicle, the vehicle should enter a charging station and should be parked on a wireless charging device in which a pad for wireless charging is located.

In order to charge the electric vehicle in this process, a driver charges the battery while waiting for 30 minutes to one hour or more, and thus, there is a problem that a time consumption is large.

In addition, in order to charge the driving vehicle in the autonomous driving system, it is not possible to know that the charging vehicle should be close to which location of the driving vehicle, a general vehicle is mixed with an autonomous vehicle on a driving road, and thus, there is a problem that it is difficult to secure safety during charging.

Moreover, there is a problem that locations of the autonomous electric vehicle and the charging vehicle to be located for charging should be changed according to a road status (traffic of vehicle, and height, curvature, or breakage of road).

In order to solve the above-described problems, the present invention proposes a method for charging the battery of the autonomous electric vehicle through the charging vehicle during driving using an audio video navigation (AVN) system.

FIG. 12 shows an example of a method for charging a battery of a vehicle during driving of the vehicle in the autonomous driving system according to an embodiment of the present invention.

With reference to FIG. 12, when charging of the battery is necessary while the autonomous electric vehicle (hereinafter, referred to as a driving vehicle) drives, the driving vehicle requests the charging to a control tower, and thus, the battery of the driving vehicle can be charged by a vehicle for charging (hereinafter, referred to as a charging vehicle).

Specifically, a wireless charging system for charging the battery of the driving vehicle in the autonomous driving system may include a driving vehicle 1210, a charging vehicle 1220, a control center (or network, 1240), and a road side unit (RSU, 1230).

The driving vehicle 1210 determines that charging of the battery is necessary while the driving vehicle 1210 drives on a road through a determined path according to a destination, the driving vehicle 1210 may transmit a request message for requesting the charging of the battery to the control center 1240.

In this case, the request message may be transmitted through the RSU 1230 and may include vehicle information of the driving vehicle 1210.

The vehicle information may include location information related to a location of the driving vehicle 1210 and battery information related to a remaining battery capacity.

If the control center 1240 receives the request message from the driving vehicle 1210, the control center 1240 determines (calculates) a lane to be occupied to perform the charging during driving in consideration of vehicle traffic (traffic congestion) of a road on which the driving vehicle 1210 is driving, based on the vehicle information.

That is, the control center 1240 determines the lane to be occupied, an occupancy time to charge the battery while the driving vehicle 1210 and the charging vehicle 1220 drive, based on current vehicle traffic of the driving road and a road status of the driving vehicle 1210.

In this case, in the occupied lane, the driving vehicle 1210 and the charging vehicle 1220 may occupy at least one lane according to a charging method.

Based on the calculated information, the control center 1240 may transmit a control message including location information related to a location (location of road for battery charging) at which the driving vehicle 1210 and the charging vehicle 1220 join for the charging, lane information related to an occupancy lane occupied for the battery charging, and time information related to the occupancy time of the occupancy lane, to the driving vehicle 1210 and the charging vehicle 1220.

In this case, the control message may be transmitted through the RSU (1230), and the message may have a V2X message format.

If the charging vehicle 1220 receives the request message for requesting (or instructing) the battery charging of the driving vehicle 1210 from the control center 1240, the charging vehicle moves to the driving vehicle for the charging.

In this case, the request message may include the vehicle information acquired by the control center 1240 from the driving vehicle 1210.

If the charging vehicle 1220 receive the control message from the control center 1240, the charging vehicle 1220 may move to a joining location and may try to charge the battery of the driving vehicle 1210 in the occupancy lane.

If the charging vehicle 1220 is located at the joining location, the driving vehicle 1210 may inform the charging vehicle of a location at which the wireless charging device for charging the battery of the driving vehicle is located.

In this case, the charging vehicle 1220 may transmit the request message requesting the location information of the wireless charging devices to the driving vehicle 1210, and as a response thereto, may receive a response message including the location information.

If the charging vehicle 1220 acquires the location information, the charging vehicle 1220 may output the locations of the wireless charging devices of the driving vehicle 1210 to an output unit using the AVN system and may acquire the location of the wireless charging device to be used by the user for the charging.

That is, the charging vehicle 1220 may receive the input of the location to be charged among mounting locations of the wireless charging device from the user, and may locate the wireless charging device (second wireless charging device) of the charging vehicle 1220 at the wireless charging device (first wireless charging device) of the input location to charge the battery of the driving vehicle 1210.

The charging device 1220 may change the location according to the location of the wireless charging device of the driving vehicle 1210 to perform an operation for wireless charging.

The charging vehicle 1220 may pull out the wireless charging device from a lower portion or an upper portion of the vehicle, may move the wireless charging device according the input charging position, and may charge the battery through the wireless charging device of the driving vehicle 1210.

In this case, the battery of the driving vehicle 1210 may be charged while the driving vehicle 1210 moves toward the destination, the charging vehicle 1220 may be located at a location close to the driving vehicle 1210 and may charge the battery of the driving vehicle 1210 while driving at the same speed as that of the driving vehicle 1210.

If a distance between the driving vehicle 1210 and the charging vehicle 1220 increases, strength of a magnetic field may decrease, and thus, the battery charging may not be performed smoothly. Accordingly, the charging vehicle 1220 may adjust a speed of the charging vehicle 1220 so that the distance between the charging vehicle 1220 and the driving vehicle 1210 does not exceed a predetermined distance, or may adjust the strength of the magnetic field so that the strength of the magnetic field is not smaller than the minimum threshold value according to the distance.

In this case, the minimum threshold value means the minimum strength of the magnetic field for the charging vehicle 1220 to charge the battery of the driving vehicle 1210 using the wireless charging device.

That is, the charging vehicle 1220 may adjust a voltage value and/or a current value so that the strength of the magnetic field always maintains the minimum threshold value or more or may adjust the speed so that the distance between the charging vehicle 1220 and the driving vehicle 1210 is within a predetermined distance.

When the charging vehicle 1220 is difficult to approach the driving vehicle 1210 due to other vehicles on the driving road, a V2X message is broadcasted to request other vehicles to move the lane.

That is, when a close location between the charging vehicle 1220 and the driving vehicle 1210 is difficult to be secured, the charging vehicle 1210 may transmit the V2X message to other adjacent vehicles to request that the other vehicles move from the lane.

When the driving vehicle 1210 and the charging vehicle 1220 are difficult to drive at the close location due to an increase in traffic on the road, the control center 1240 may inform the driving vehicle 1210 and the charging vehicle 1220 of a path with less vehicle traffic for the charging through the RSU 1230.

In this case, the control center 1240 may transmit path information indicating the path with less vehicle traffic to the driving vehicle 1210 and/or the charting vehicle 1220 through the V2X message.

In this case, the driving vehicle 1210 and the charging vehicle 1220 change the paths according to the received path information, and may perform the charging in the changed path.

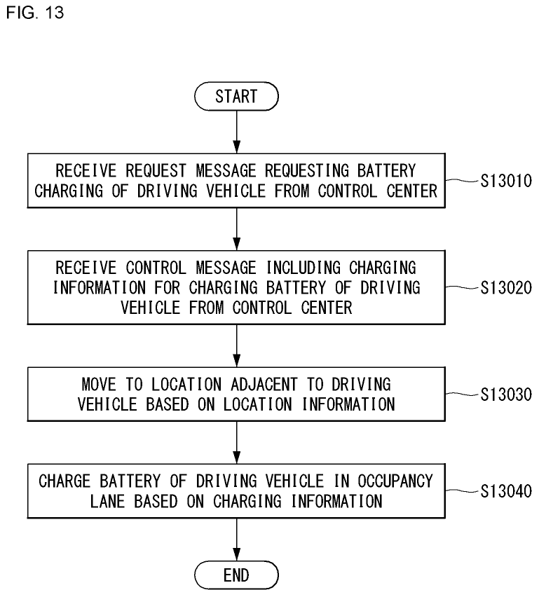

FIG. 13 shows an example of a method for charging the battery of the driving vehicle by the charging vehicle in the autonomous driving system according to an embodiment of the present invention.

With reference to FIG. 13, if the charging vehicle receives the request of the charging of the driving vehicle from the control center, the charging vehicle moves to the location at which the driving vehicle drives and may charge the battery of the driving vehicle.

Specifically, if the charging vehicle receives the request message requesting (or instructing) the battery charging of the driving vehicle from the control center, the charging vehicle moves to a road on which the driving vehicle drives to perform the charging (S13010).

In this case, the request message may include the vehicle information acquired by the control center from the driving vehicle, and the vehicle information may include the location information related to the location of the driving vehicle and battery information related to the remaining battery capacity.

Thereafter, the charging vehicle may receive a control message including charging information for charging the battery of the driving vehicle (S13020).

The control message may include location information related to a location (that is, location of road for battery charging) at which the driving vehicle and the charging vehicle are joined to each other for the charging, lane information related to the occupancy lane which is occupied for the battering charging, and time information related to the occupancy time of the occupancy lane.

In this case, the occupancy lane and/or the occupancy time is determined by the control center in consideration of the vehicle traffic (traffic congestion) of the road on which the driving vehicle is driving, based on the vehicle information.

If the charging vehicle receives the control message from the control center, the charging vehicle moves to the joining location (S13030), and if the charging vehicle arrives at a location adjacent to the driving vehicle, the charging vehicle may try the charging of the battery of the driving vehicle in the occupancy lane (S13040).

Specifically, if the charging vehicle arrives at the joining location, the charging vehicle may acquire a location at which the wireless charging device for charging the battery of the driving vehicle is located, from the driving vehicle.

In this case, the charging vehicle may transmit the request message requesting the location information of the wireless charging devices to the driving vehicle, and as a response thereto, may receive a response message including the location information.

If the charging vehicle acquires the location information, the charging vehicle may output the locations of the wireless charging devices of the driving vehicle to the output unit using the AVN system and may acquire the location of the wireless charging device to be used by the user for the charging.

That is, the charging vehicle may receive the input of the location to be charged among mounting locations of the wireless charging device from the user, and may locate the wireless charging device (second wireless charging device) of the charging vehicle at the wireless charging device (first wireless charging device) of the input location to charge the battery of the driving vehicle.

The charging device may change the location according to the location of the wireless charging device of the driving vehicle to perform the operation for wireless charging.

In this case, the charging vehicle may be located at the location close to the driving vehicle and may charge the battery of the driving vehicle while driving at the same speed as that of the driving vehicle.

If the distance between the driving vehicle and the charging vehicle increases, the strength of the magnetic field may decrease, and thus, the battery charging may not be performed smoothly. Accordingly, the charging vehicle may adjust a speed of the charging vehicle so that the distance between the charging vehicle and the driving vehicle does not exceed a predetermined distance, or may adjust the strength of the magnetic field so that the strength of the magnetic field is not smaller than the minimum threshold value according to the distance.

In this case, the minimum threshold value means the minimum strength of the magnetic field for the charging vehicle to charge the battery of the driving vehicle using the wireless charging device.

That is, the charging vehicle may adjust the voltage value and/or the current value so that the strength of the magnetic field always maintains the minimum threshold value or more or may adjust the speed so that the distance between the charging vehicle and the driving vehicle is within a predetermined distance.

When the charging vehicle is difficult to approach the driving vehicle due to other vehicles on the driving road, the V2X message is broadcasted to request that other vehicles move from the lane.

That is, when the close location between the charging vehicle and the driving vehicle is difficult to be secured, the charging vehicle may transmit the V2X message to other adjacent vehicles to request that the other vehicles move from the lane.

When the driving vehicle and the charging vehicle are difficult to drive at the close location due to the increase in the traffic on the road, the control center may inform the driving vehicle and the charging vehicle of a path with less vehicle traffic for the charging through the RSU.

In this case, the charging vehicle may receive the path information indicating the path with less vehicle traffic through the V2X message from the control center, may change the path according to the received path information, and may charge the battery of the driving vehicle in the changed path.

In this way, the charging vehicle can charge the battery of the driving vehicle during driving.

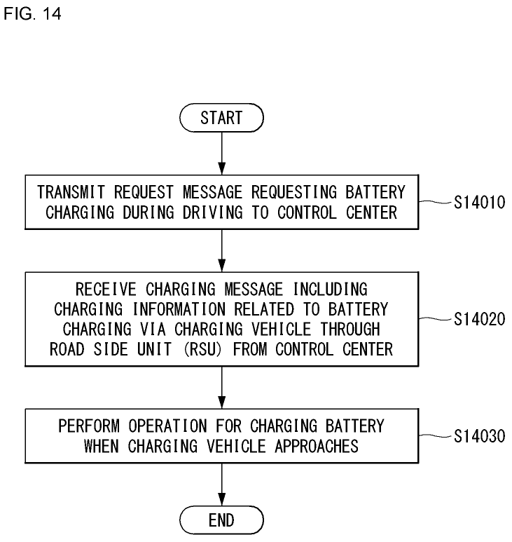

FIG. 14 shows an example of a method for charging the battery of the driving vehicle in the autonomous driving system according to an embodiment of the present invention.

With reference to FIG. 14, when the driving vehicle needs to charge the battery to move to the destination while driving, the driving vehicle requests the charging of the battery to the control center and may charge the battery while driving.

Specifically, if the driving vehicle determines that the battery needs to be charged while driving on a road through a path determined according to the destination, the driving vehicle may transmit a request message requesting the charging of the battery to the control center (S14010).

The request message may be transmitted through the RSU located around the load and may include the vehicle information of the driving vehicle.

The vehicle information may include the location information related to the location of the driving vehicle and battery information related to the remaining battery capacity.

The driving vehicle may receive, through the RSU from the control center, the control message including location information related to the location (that is, location of road for battery charging) at which the driving vehicle and the charging vehicle are joined to each other for the charging, the lane information related to the occupancy lane which is occupied for the battering charging, and time information related to the occupancy time of the occupancy lane (S14020).

In this case, the occupancy lane and/or the occupancy time is determined by the control center in consideration of the vehicle traffic (traffic congestion) of the road on which the driving vehicle is driving, based on the vehicle information.

Thereafter, when the charging vehicle approaches the occupancy lane, an operation for the battery charging may be performed (S14030).

Specifically, if the charging vehicle is located at the joining location, the driving vehicle may inform the charging vehicle of the location at which the wireless charging device for the battery charging of the driving vehicle is located.

When the driving vehicle and the charging vehicle are difficult to drive at the close location due to the increase in the traffic on the road, the control center may inform the driving vehicle of the path with less vehicle traffic for the charging through the RSU.

That is, the driving vehicle may receive the path information indicating the path with less vehicle traffic through the V2X message from the control center.

In this case, the driving vehicle and the charging vehicle change the paths according to the received path information, and may perform the charging in the changed path.

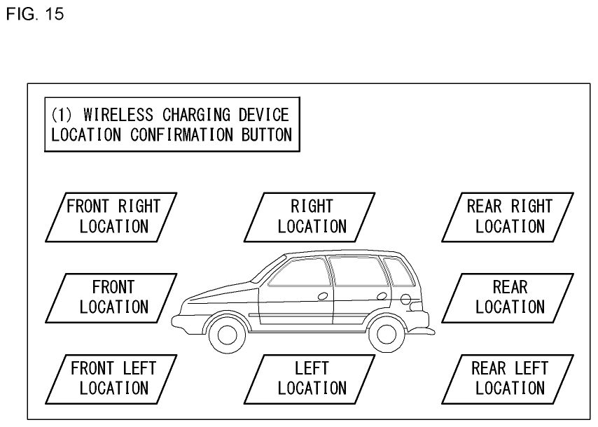

FIG. 15 shows an example of a method for determining the charging location using the audio video navigation (AVN) system according to an embodiment of the present invention.

With reference to FIG. 15, the driving vehicle may inform the user of the locations at which the wireless charging devices of the driving vehicle are located through the AVN system, and may receive the input of the location of the wireless charging device to be used for the charging, through the charging vehicle from the user.

Specifically, as described in FIGS. 12 to 14, when the charging of the battery of the driving vehicle is necessary and the charging vehicle approaches the driving vehicle, the charging vehicle may transmit the V2X message to the driving vehicle to inquire the locations of the wireless charging devices of the driving vehicle.

For example, as shown in FIG. 15, the charging vehicle may output a button for confirming the location of the wireless charging device through the output unit of the AVN system, and if the user pushes this button, the charging vehicle may transmit the V2X message to the driving vehicle to inquire the locations of the wireless charging devices of the driving vehicle.

Thereafter, if the charging vehicle acquires the location information indicating the locations of the wireless charging devices of the driving vehicle, through the V2X message from the driving vehicle, as shown in FIG. 15, the charging vehicle may output the wireless charging locations of the driving vehicle.

The charging vehicle may receive an input of the location of the wireless charging device (first wireless charging device) to be used for the charging among the wireless charging devices of the driving vehicle, from the user through a UI screen shown in FIG. 15.

Thereafter, the charging vehicle may receive the input of the location to be charged among the mounting locations of the wireless charging devices from the user, and may locate the wireless charging device (second wireless charging device) of the charging vehicle at the wireless charging device (first wireless charging device) of the input location to charge the battery of the driving vehicle.

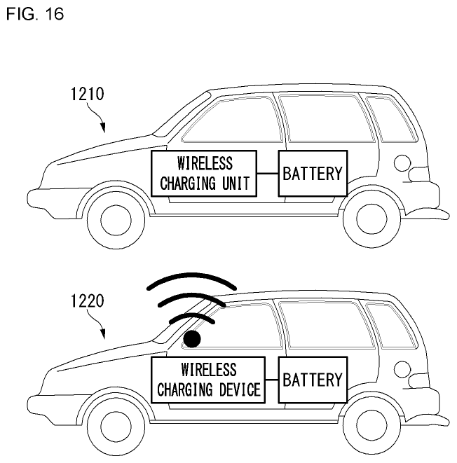

FIG. 16 shows an example of a method for charging the battery during driving in the autonomous driving system according to an embodiment of the present invention.

With reference to FIG. 16, if the charging vehicle arrives the joining location, the charging vehicle may attempt to charge the battery of the driving vehicle in a state where the speed of the charging vehicle matches with the speed of the driving vehicle.

Specifically, as described in FIG. 12, if the charging vehicle 1220 receives the request message and the control message for charging the battery of the driving vehicle 1210 from the control center and arrives at the occupancy lane of the joining location, the charging vehicle 1220 can match with the speed of the driving vehicle.

Thereafter, as described in FIG. 15, if the first wireless charging device is selected based on the input information input by the user, the charging vehicle 1220 changes the location according to the location of the wireless charging device of the driving vehicle 1210, and may perform the operation for the wireless charging.

Specifically, the charging vehicle 1220 may transmit a request message requesting that other vehicles do not enter the occupancy lane, to the control center through a C-V2X.

The control center may broadcast an instruction message instructing that the occupancy lane is not used during the occupancy time through the RSU of the corresponding road section so that the driving vehicle 1210 and the charging vehicle 1220 perform the battery charging operation in the occupancy lane during the occupancy time.

The charging vehicle 1220 may output an electric signal from the second wireless charging device according to the first wireless charging device location of the driving vehicle 1210 and charge the battery.

For example, when the wireless charging devices of the driving vehicle are located at a side (right/left) and front surface/rear surface of the vehicle, the charging vehicle may output the electric signal for the battery charging from the second wireless charging devices located at a side (right/left) and front surface/rear surface of the charging vehicle.

If the electric signal output from the charging vehicle 1220 is weak to charge the battery, the driving vehicle 1210 may transmit a message requesting an increase in the electric signal or a reduction of the distance between the driving vehicle 1210 and the charging vehicle 1220.

If the charging vehicle 1220 receives the request message from the driving vehicle 1210, the charging vehicle 1220 may adjust a speed of the charging vehicle 1220 so that the distance between the charging vehicle 1220 and the driving vehicle 1210 does not exceed a predetermined distance, or may adjust the strength of the magnetic field so that the strength of the magnetic field is not smaller than the minimum threshold value according to the distance.

In this case, the minimum threshold value means the minimum strength of the magnetic field for the charging vehicle 1220 to charge the battery of the driving vehicle 1210 using the wireless charging device.

That is, the charging vehicle 1220 may adjust the voltage value and/or the current value so that the strength of the magnetic field always maintains the minimum threshold value or more or may adjust the speed so that the distance between the charging vehicle 1220 and the driving vehicle 1210 is within a predetermined distance.

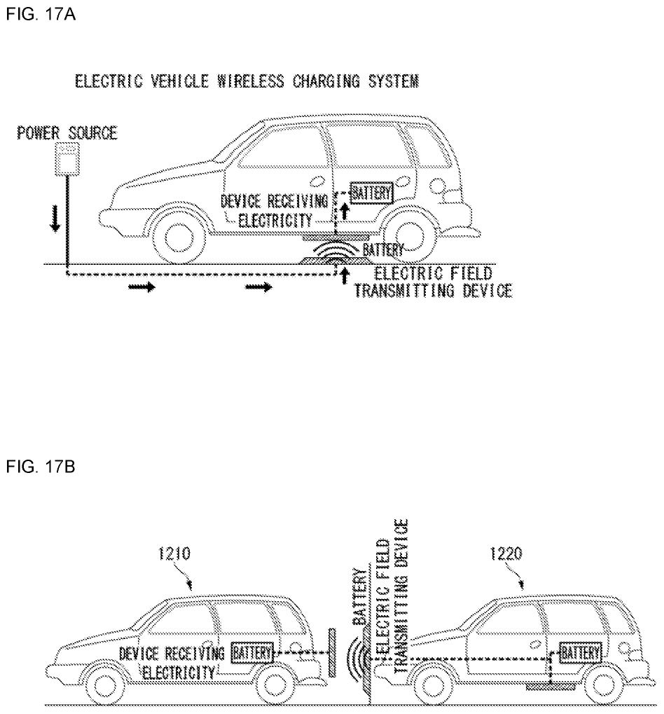

FIGS. 17A to 19 show an example of a change in the location of the charging vehicle according to the location of the driving vehicle in the autonomous driving system according to an embodiment of the present invention.

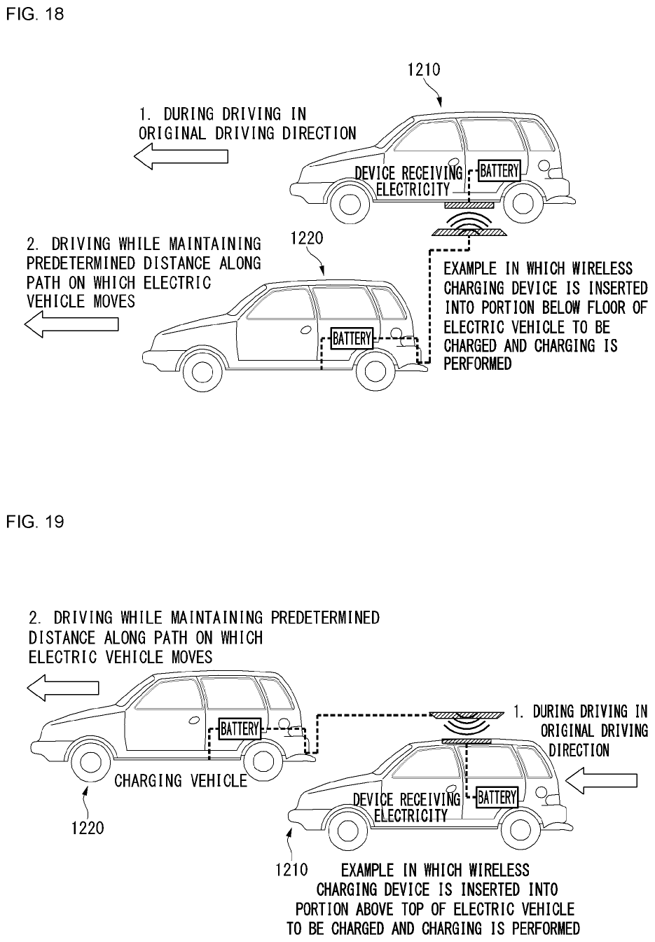

FIGS. 17A and 17B show an example when the wireless charging device is located on a rear surface of the driving vehicle, FIG. 18 shows an example when the wireless charging device is located in a lower portion of the driving vehicle, and FIG. 19 shows an example when the wireless charging device is located in an upper portion of the driving vehicle.

FIG. 17A shows a method in which the driving vehicle enters a charging station and perform the wireless charging in the related art, and as shown in FIG. 17A, when the wireless charging device is located in a lower portion of the driving vehicle, the driving vehicle moves to the charging station and charges the battery using the wireless charging device.

However, as shown in FIG. 17B, when the first wireless charging device is located on the rear surface of the driving vehicle 1210, in order to charge the battery using the charging vehicle 1220 during driving, the charging vehicle 1220 is located behind the driving vehicle 1210, an electric field is generated by the second wireless charging device located on a front surface of the charging vehicle 1220, and thus, the battery of the driving battery 1210 can be charged.

In this case, only one lane may be occupied for the charging.

As shown in FIG. 18, when the first wireless charging device is located on a floor of the driving vehicle, while the driving vehicle 1210 continuously drives in an original driving direction, the charging vehicle 1220 is located in a lane next to the driving vehicle 1210 and may drive while maintaining a predetermined distance along a moving path of the driving vehicle 1210.

In this case, as shown in FIG. 18, the second wireless charging device of the charging vehicle 1220 is inserted into a portion below the driving vehicle 1210, and thus, the electric signal may be transmitted to the first wireless charging device to charge the battery.

In this case, two or more lanes may be occupied for the charging.

As shown in FIG. 19, when the first wireless charging device is located in the upper portion of the driving vehicle, while the driving vehicle 1210 continuously drives in the original driving direction, the charging vehicle 1220 is located in the same lane as or the lane next to the lane of driving vehicle 1210 and may drive while maintaining a predetermined distance along the moving path of the driving vehicle 1210.

If the charging vehicle 1220 and the driving vehicle 1210 are located in the same lane, the charging vehicle 1220 may be located in front of the driving vehicle 1210.

In this case, as shown in FIG. 18, the second wireless charging device of the charging vehicle 1220 is inserted into a portion above the driving vehicle 1210, and thus, the electric signal may be transmitted to the first wireless charging device to charge the battery.

In this case, one or more lanes may be occupied for the charging.

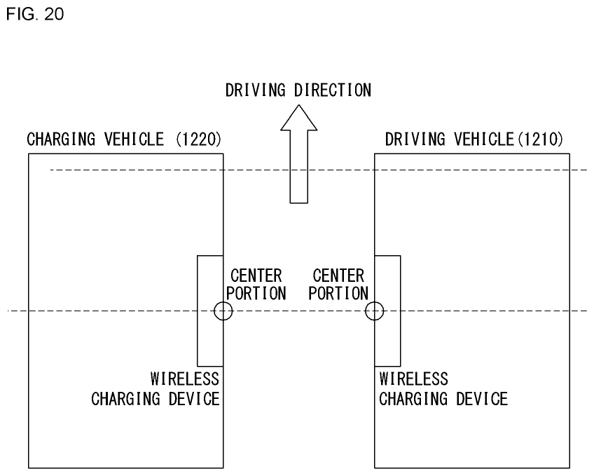

FIG. 20 shows an example of a method for determining locations of the driving vehicle and the charging vehicle during driving according to a status of a road according to an embodiment of the present invention.

With reference to FIG. 20, when heights of locations of the charging vehicle and the driving vehicle are changed according to a road status (curvature or breakage of road), the charging vehicle and the driving vehicle may change the strength of the magnetic field and/or the location of the wireless charging device to charge the battery.

Specifically, according to the method described in FIGS. 12 to 14, when the charging vehicle 1220 and the driving vehicle 1210 occupy the occupancy lane at the joining location and perform the operation for charging the battery during the occupancy time, in a case where heights of center portions of the charging vehicle 1220 and the driving vehicle 1210 are different from each other, the battery charging through the wireless charging device may not be performed smoothly.

In this case, as shown in FIG. 20, the locations of the charging vehicle 1220 and the driving vehicle 1210 may be changed such that the center portions of the charging vehicle 1220 and the driving vehicle 1210 are located at the same location as each other, and the location of the charging vehicle 1220 may be changed to a location at which the strength of the magnetic field applied to the first wireless charging device of the driving vehicle 1210 is the strongest.

In this case, when the distance between the charging vehicle 1220 and the driving vehicle 1210 is large, the strength of the magnetic field is weakened, and thus, the charging may not be performed smoothly.

Accordingly, the charging vehicle 1220 may adjust a speed of the charging vehicle 1220 so that the distance between the charging vehicle 1220 and the driving vehicle 1210 does not exceed a predetermined distance, or may adjust the strength of the magnetic field so that the strength of the magnetic field is not smaller than the minimum threshold value according to the distance.

In this case, the minimum threshold value means the minimum strength of the magnetic field for the charging vehicle to charge the battery of the driving vehicle using the wireless charging device.

That is, the charging vehicle may adjust the voltage value and/or the current value so that the strength of the magnetic field always maintains the minimum threshold value or more or may adjust the speed so that the distance between the charging vehicle and the driving vehicle is within a predetermined distance.

When the charging vehicle is difficult to approach the driving vehicle due to other vehicles on the driving road, the V2X message is broadcasted to request other vehicles to move the lane.

That is, when the close location between the charging vehicle and the driving vehicle is difficult to be secured, the charging vehicle may transmit the V2X message to other adjacent vehicles to request that the other vehicles move from the lane.

Hereinafter, various embodiments of the method for charging the battery performed by the charging vehicle in the autonomous driving system according to the embodiments of the present invention will be described.

Embodiment 1: A method for charging a battery performed by a charging vehicle in an autonomous driving system, the method including: receiving a request message requesting charging of a battery of a driving vehicle from a control center, the request message including first location information related to a location of the driving vehicle and battery information related to a remaining battery capacity of the driving vehicle; receiving a control message including charging information for charging the battery of the driving vehicle from the control center, the charging information including road location information related to a road location for the battery charging, lane information related to an occupancy lane occupied for charging, and time information related to an occupancy time of the occupancy lane; moving the charging vehicle to a location adjacent to the driving vehicle based on the first location information; and charging the battery of the driving vehicle in the occupancy lane based on the charging information.

Embodiment 2: In Embodiment 1, the charging information is generated based on a current location of the driving vehicle and/or traffic congestion on a path to a destination.

Embodiment 3: In Embodiment 1, the method further includes acquiring second location information indicating locations of wireless charging devices for the battery charging from the driving vehicle, and acquiring charging location information related to a location of a first wireless charging device for the battery charging among the wireless charging devices from a user.

Embodiment 4: In Embodiment 3, the method further includes moving the charging vehicle to a location closest to the first wireless charging device based on the charging location information.

Embodiment 5: In Embodiment 1, the method further include, when strength of a magnetic field for the battery charging is smaller than the minimum threshold value, adjusting a voltage value and/or a current value so as to increase the strength of the magnetic field.

Embodiment 6: In Embodiment 1, the method further includes, when other vehicles drive in the occupancy lane, transmitting a lane change request message requesting that other vehicles change a lane to other vehicles, and a speed of the charging vehicle is adjusted so that the charging vehicle is located within a predetermined distance from the driving vehicle.

Embodiment 7: In Embodiment 1, the method further includes, when heights of the driving vehicle and the charging vehicle are different from each other, moving the driving vehicle and the charging vehicle so that a center portion of a first wireless charging device of the driving vehicle and a center portion of a second wireless charging device of the charging vehicle are located at the same location as each other in a horizontal axis.

Embodiment 8: In Embodiment 7, the method further includes moving the charging vehicle to a location at which the strength of the magnetic field for the battery charging is the strongest.

Embodiment 9: In Embodiment 1, a second wireless charging device of the charging vehicle moves along a location of a first wireless charging device of the driving vehicle.

Embodiment 10: A method for charging a battery performed by a driving vehicle in an autonomous driving system, the method including: transmitting a request message requesting charging of a battery during driving to a control center, the request message including location information related to a location of the driving vehicle and battery information related to a remaining battery capacity of the driving vehicle; receiving a charging message including charging information related to battery charging via a charging vehicle through a road side unit (RSU) from the control center, the charging information including location information related to a road location for the battery charging, lane information related to an occupancy lane occupied for charging, and time information related to an occupancy time of the occupancy lane; and performing an operation for charging the battery when the charging vehicle approaches.

Embodiment 11: In Embodiment 10, the method further includes receiving an input of charging location information related to a location of a wireless charging device for the charging of the battery, from a user of the driving vehicle.

Embodiment 12: A charging vehicle for battery charging in an autonomous driving system, the charging vehicle including: a wireless charging device for wireless charging; a transmitter and a receiver configured to communicate with a sever; a processor configured to be functionally connected to the transmitter and the receiver, in which the processor receives a request message requesting charging of a battery of a driving vehicle from a control center, the request message including location information related to a location of the driving vehicle and battery information related to a remaining battery capacity of the driving vehicle, the processor receiving a control message including charging information for charging the battery of the driving vehicle from the control center, the charging information including location information related to a road location for the battery charging, lane information related to an occupancy lane occupied for charging, and time information related to an occupancy time of the occupancy lane, the charging vehicle moves to a location adjacent to the driving vehicle based on the location information, and the battery of the driving vehicle is charged in the occupancy lane based on the charging information.

Embodiment 13: In Embodiment 11, the charging information is generated based on a current location of the driving vehicle and/or traffic congestion on a path to a destination.

Embodiment 14: In Embodiment 11, the processor acquires charging location information related to a location of a first wireless charging devices for the battery charging from the driving vehicle.

Embodiment 15: In Embodiment 14, the processor moves the charging vehicle to a location closest to the first wireless charging device based on the charging location information.

Embodiment 16: In Embodiment 11, when strength of a magnetic field for the battery charging is smaller than the minimum threshold value, the processor adjusts a voltage value and/or a current value so as to increase the strength of the magnetic field.

Embodiment 17: In Embodiment 11, when other vehicles drive in the occupancy lane, the processor transmits a lane change request message requesting that other vehicles change a lane to other vehicles and adjusts a speed of the charging vehicle so that the charging vehicle is located within a predetermined distance from the driving vehicle.

Embodiment 18: In Embodiment 11, when heights of the driving vehicle and the charging vehicle are different from each other, the processor moves the driving vehicle and the charging vehicle so that a center portion of a first wireless charging device of the driving vehicle and a center portion of a second wireless charging device of the charging vehicle are located at the same location as each other in a horizontal axis.

Embodiment 19: In Embodiment 18, the processor moves the charging vehicle to a location at which the strength of the magnetic field for the battery charging is the strongest.

Embodiment 20: In Embodiment 11, a second wireless charging device of the charging vehicle moves along a location of a first wireless charging device of the driving vehicle.

Embodiment 21: A charging vehicle for battery charging in an autonomous driving system, the charging vehicle including: a wireless charging device for wireless charging; a transmitter and a receiver configured to communicate with a sever; and a processor configured to be functionally connected to the transmitter and the receiver, in which the processor transmits a request message requesting charging of a battery during driving from a control center and the request message includes location information related to a location of the driving vehicle and battery information related to a remaining battery capacity of the driving vehicle. In addition, the processor receives a charging message including charging information related to battery charging via a charging vehicle through a road side unit (RSU) from the control center, and the charging information includes location information related to a road location for the battery charging, lane information related to an occupancy lane occupied for charging, and time information related to an occupancy time of the occupancy lane. In addition, the processor performs an operation for charging the battery when the charging vehicle approaches.

Embodiment 22: In Embodiment 21, the processor receives an input of charging location information related to a location of a wireless charging device for the charging of the battery, from a user of the driving vehicle.

The above-described present invention can be implemented with computer-readable code in a computer-readable medium in which program has been recorded. The computer-readable medium may include all kinds of recording devices capable of storing data readable by a computer system. Examples of the computer-readable medium may include a hard disk drive (HDD), a solid state disk (SSD), a silicon disk drive (SDD), a ROM, a RAM, a CD-ROM, magnetic tapes, floppy disks, optical data storage devices, and the like and also include such a carrier-wave type implementation (for example, transmission over the Internet). Therefore, the above embodiments are to be construed in all aspects as illustrative and not restrictive. The scope of the invention should be determined by the appended claims and their legal equivalents, not by the above description, and all changes coming within the meaning and equivalency range of the appended claims are intended to be embraced therein.

Effects of the method and apparatus for charging the battery of the vehicle driving in the autonomous driving system according to an embodiment of the present invention are as follows.

In the present invention, even when the autonomous electric vehicle does not move to the charging station, the battery of the autonomous electric vehicle can be charged during driving.

Even when the vehicle does not move to the charging station, the vehicle can be charged. Accordingly, it is possible to reduce a waiting time for charging in the charging station.

The user can directly determine the location to be charged during driving through the audio video navigation (AVN) system.

The battery is charged so that the location and the lane of the road on which the battery is to be charged and the location of the vehicle during driving are changed according to the road situation, and thus, it is possible to effectively perform the charging.

Effects obtained in the present invention are not limited to the effects mentioned above, and other effects not mentioned can be clearly understood by a person skilled in the art from the above descriptions.

What is claimed is:

1. A method for charging a battery performed by a charging vehicle in an autonomous driving system, the method comprising:
receiving a request message requesting charging of a battery of a driving vehicle from a control center, the request message including first location information related to a location of the driving vehicle and battery information related to a remaining battery capacity of the driving vehicle;
receiving a control message including charging information for charging the battery of the driving vehicle from the control center, the charging information including road location information related to a road location for the battery charging, lane information related to an occupancy lane occupied for charging, and time information related to an occupancy time of the occupancy lane;
moving to a location adjacent to the driving vehicle based on the first location information; and
charging the battery of the driving vehicle in the occupancy lane based on the charging information.

2. The method of claim 1, wherein the charging information is generated based on a current location of the driving vehicle and/or traffic congestion on a path to a destination.

3. The method of claim 1, further comprising:
acquiring second location information indicating locations of wireless charging devices for the battery charging from the driving vehicle; and
acquiring charging location information related to a location of a first wireless charging device for the battery charging among the wireless charging devices from a user.

4. The method of claim 3, further comprising: moving to a location closest to the first wireless charging device based on the charging location information.

5. The method of claim 1, further comprising: when strength of a magnetic field for the battery charging is smaller than the minimum threshold value, adjusting a voltage value and/or a current value so as to increase the strength of the magnetic field.

6. The method of claim 1, further comprising: when other vehicles drive in the occupancy lane, transmitting a lane change request message requesting that other vehicles change a lane to other vehicles, wherein
a speed of the charging vehicle is adjusted so that the charging vehicle is located within a predetermined distance from the driving vehicle.

7. The method of claim 1, further comprising: when heights of the driving vehicle and the charging vehicle are different from each other, moving the driving vehicle and the charging vehicle so that a center portion of a first wireless charging device of the driving vehicle and a center portion of a second wireless charging device of the charging vehicle are located at the same location as each other in a horizontal axis.

8. The method of claim 7, further comprising: moving to a location at which the strength of the magnetic field for the battery charging is the strongest.

9. The method of claim 1, wherein a second wireless charging device of the charging vehicle moves along a location of a first wireless charging device of the driving vehicle.

10. A method for charging a battery performed by a driving vehicle in an autonomous driving system, the method comprising:
transmitting a request message requesting charging of a battery during driving to a control center, the request message including location information related to a location of the driving vehicle and battery information related to a remaining battery capacity of the driving vehicle;
receiving a charging message including charging information related to battery charging via a charging vehicle through a road side unit (RSU) from the control center, the charging information including location information related to a road location for the battery charging, lane information related to an occupancy lane occupied for charging, and time information related to an occupancy time of the occupancy lane; and
performing an operation for charging the battery when the charging vehicle approaches.

11. The method of claim 10, further comprising: receiving an input of charging location information related to a location of a wireless charging device for the charging of the battery, from a user of the driving vehicle.

12. A charging vehicle for battery charging in an autonomous driving system, the charging vehicle comprising:
a wireless charging device for wireless charging;
a transmitter and a receiver configured to communicate with a sever; and
a processor configured to be functionally connected to the transmitter and the receiver, wherein
the processor receives a request message requesting charging of a battery of a driving vehicle from a control center, the request message including location information related to a location of the driving vehicle and battery information related to a remaining battery capacity of the driving vehicle,
the processor receives a control message including charging information for charging the battery of the driving vehicle from the control center, the charging information including location information related to a road location for the battery charging, lane information related to an occupancy lane occupied for charging, and time information related to an occupancy time of the occupancy lane,
moves to a location adjacent to the driving vehicle based on the location information, and
the battery of the driving vehicle is charged in the occupancy lane based on the charging information.

13. The charging vehicle of claim 12, wherein the charging information is generated based on a current location of the driving vehicle and/or traffic congestion on a path to a destination.

14. The charging vehicle of claim 12, wherein the processor acquires charging location information related to a location of a first wireless charging device for the battery charging from the driving vehicle.

15. The charging vehicle of claim 14, wherein the processor moves to a location closest to the first wireless charging device based on the charging location information.

16. The method of claim 12, when strength of a magnetic field for the battery charging is smaller than the minimum threshold value, the processor adjusts a voltage value and/or a current value so as to increase the strength of the magnetic field.

17. The method of claim 12, wherein when other vehicles drive in the occupancy lane, the processor transmits a lane change request message requesting that other vehicles change a lane to other vehicles and adjusts a speed of the charging vehicle so that the charging vehicle is located within a predetermined distance from the driving vehicle.

18. The method of claim 12, wherein when heights of the driving vehicle and the charging vehicle are different from each other, the processor moves the driving vehicle and the charging vehicle so that a center portion of a first wireless charging device of the driving vehicle and a center portion of a second wireless charging device of the charging vehicle are located at the same location as each other in a horizontal axis.

19. The method of claim 18, wherein the processor moves to a location at which the strength of the magnetic field for the battery charging is the strongest.

20. The method of claim 12, wherein a second wireless charging device of the charging vehicle moves along a location of a first wireless charging device of the driving vehicle.
